(19) United States
(12) Patent Application Publication
(10) Pub. No.: US 2026/0300328 A1
(43) Pub. Date: Oct. 1, 2026

(54) Helping Users Interactively Discover And Explore Personalized Living Locations

(71) Applicant: Richard Heggem, Post Falls, ID (US)

(72) Inventor: Richard Heggem, Post Falls, ID (US)

(73) Assignee: Richard Heggem, Post Falls, ID (US)

(21) Appl. No.: 19/096,575

(22) Filed: Mar. 31, 2025

(51) Int. Cl. G06F 16/29; G06F 3/0484; G06Q 50/16

(52) U.S. Cl. CPC G06F 16/29; G06F 3/0484; G06Q 50/16

(57) ABSTRACT

A system assists users to identify locations compatible with their needs and interests. A user interacts with a graphical user interface (GUI) to select a set of attributes of interest to the user. Interests include recreation, demographics, and family and friend relationships. The system identifies a set of geographic boundaries associated with the user-selected attributes. Boundaries include irregular shapes, shapes based on political boundaries, and circular boundaries. The system identifies a set of candidate locations based on overlapping geographic boundaries. The system presents the set of candidate locations to the user in the GUI.

### TECHNICAL FIELD

The present application relates generally to information management systems and, more specifically, to a machine-implemented architecture for helping users interactively discover and explore personalized living locations.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Tens of millions of people relocate in America every year. More than ⅓ of all Americans don't live in their birth state. The average American moves 11.7 times in their life.

Best-selling author Richard Florida stresses the importance of where we live when he writes, “The place we choose to live affects every aspect of our being. It can determine the income we earn, the people we meet, the friends we make, the partners we choose, and the options available to our children and families. People are not equally happy everywhere, and some places do a better job of providing a high quality of life than others.”

Dr. Florida further observes, “The stakes are high, and yet, when faced with the decision of where to call home, most of us are not prepared to make the right choice. If you ask most people how they got to the place they live now, they'll say they just ended up there . . . . Some don't even see that there's a choice to be made at all.”

Deciding where to move is a complex exercise, wrought with decision fatigue for many. And no wonder since there are scores or hundreds of attributes to consider when making a move. Considerations about crime, demographics, economics, schools, pollution, access to medical care, housing, natural disasters, politics, population, proximity to family, religion, taxes, transportation, weather, and others should all be considered by prudent people. And yet, the effort required to collect this information for every possible place to live, along with so many other attributes (e.g., golf, fishing, dining, arts and entertainment, etc.), make this a nearly impossible task for the average person. Even if the information was readily available, which it frequently is not, assembling it all into an actionable form could become a full-time occupation.

The complexity described above is further heightened by the fact that most people don't know even the attributes that are important to them. Asking them what's important to them in a new location often elicits a blank star and the most simplistic response, such as “I just don't want to live in the snow,” as if that is the only attribute. Does that mean they are OK with living in the “tornado belt,” in a flood zone, or a high crime area? Of course not. It's just that all those attributes, as important as they are to the prospective mover, are not “on their radar.” That is, they are utterly unaware of attributes that are critically important to them, were they aware.

The preceding complexities and decision fatigue have made many susceptible to the proliferation of articles and videos on the topic of “The 25 Best Places to Live in America,” or similar. There are hundreds of such pieces of content, many published by leading media outlets. Of course, such articles are fantasies unless the reader/viewer of the article/video has the exact needs and interests as the author/publisher-which is highly unlikely. Logically, there is no “THE best place” for everyone. However, there is “A best place” for each person.

Interest in moving is often accelerated by changing circumstances or changing technology. For example, during the Covid experience in 2020 and 2021, 46 million Americans reassessed where they lived. And the broad emergence of remote working, resulting from the Covid lockdowns, opened the door to relocation where it was previously unthinkable.

According to author Melody Warnick, there are 117 million “anywhereists” in America-people who could live and work anywhere. Anywhereists include not just remote workers but also transferrable career workers like doctors, lawyers, and teachers.

The old saying, “It looks good on paper,” applies to relocation. Even if a prospective mover's preferences are met “on paper” (stage 1), they still need to confirm the decision, most often by a visit to the location and further investigation (stage 2). To complete stage 2, additional resources are required, including access to local news, advisement by professional service providers (e.g., realtors or movers), travel services (e.g., hotels, flights, cars, etc.), and the advice or experiences of others who live or lived at the desired location.

Based on the preceding, an approach for helping users interactively discover and explore ideal personalized living locations that does not suffer from limitations in prior approaches is highly desirable.

### BRIEF DESCRIPTION OF THE DRAWINGS

Implementations are depicted by way of example, and not by way of limitation, in the figures of the accompanying drawings and in which like reference numerals refer to similar elements and in which:

FIG. 1 is a block diagram that depicts a system for helping users interactively discover and explore ideal personalized living locations, in accordance with an implementation.

FIG. 2A is a block diagram that depicts front-end application components for helping users interactively discover and explore ideal personalized living locations, in accordance with an implementation.

FIG. 2B is a block diagram that depicts server components for helping users interactively discover and explore ideal personalized living locations, in accordance with an implementation.

FIG. 3 is a block diagram of a ranking engine that depicts an approach for a ranking personalized location matches, in accordance with an implementation.

FIG. 4 is a block diagram of a correlation engine that depicts an approach for correlating attributes for multiple locations favored by a prospective mover, in accordance with an implementation.

FIG. 5 is a block diagram that depicts an approach for enhancing system performance, in accordance with an implementation.

FIG. 6 is a flow diagram that depicts an approach for finding best match locations using attribute selection and limit setting, in accordance with an implementation.

FIG. 7 is a flow diagram that depicts an approach for finding best match locations using reference locations and automatic limit setting, in accordance with an implementation.

FIG. 8A is a depiction of a slider control approach for establishing attribute limit ranges, in accordance with an implementation.

FIG. 8B is a depiction of a toggle filter control approach for establishing attribute limits, in accordance with an implementation.

FIG. 8C is a depiction of a ladder filter control approach for establishing attribute limits, in accordance with an implementation.

FIG. 9A is a depiction of a map view colorized to display best-match locations in accordance with an implementation.

FIG. 9B is a depiction of a list view colorized and ranked to display best-match locations in accordance with an implementation.

FIG. 9C is a depiction of a location profile with both qualitative and quantitative data to characterize the location and present links for further exploration in accordance with an implementation.

FIG. 9D is a depiction of a location profile with exploration-enhancing advertisements in accordance with an implementation.

FIG. 10A is a depiction of a colorized heatmap to display the variability of a given attribute in accordance with an implementation.

FIGS. 10B and 10C depict a list view of the heatmap results displayed in rank order in accordance with an implementation.

FIG. 11A is a display of a map depicting a prospective mover's favorite locations in accordance with an implementation.

FIG. 11B is a display of a list depicting a prospective mover's favorite locations in accordance with an implementation.

FIG. 12A is a display of a user interface with an option to isolate a single attribute and its control for modification in accordance with an implementation.

FIG. 12B is a display of a user interface isolating a single attribute and providing control for its modification in accordance with an implementation.

FIG. 13A is a display of a user interface with an option to allow attributes to be more highly weighted in the best location match rankings in accordance with an implementation.

FIG. 13B is a display of a user interface whereby some attributes have been more highly weighted in the best location match rankings in accordance with an implementation.

FIG. 14A is a display of a user interface allowing prospective mover's experience to be shared with others in accordance with an implementation.

FIG. 14B is a display of a user interface allowing attributes or favorites to be shared through different media channels in accordance with an implementation.

FIG. 14C is a display of a user interface allowing shares to have a read-only experience of the original prospective mover's account in accordance with an implementation.

FIG. 15 is a display of a user interface allowing users to see the score and rank of their current living location, their reference locations, and their favorite locations in accordance with an implementation.

FIG. 16 is a block diagram that illustrates a computer system upon which an implementation may be implemented.

FIGS. 17A and 17B illustrate a set of example operations for identifying locations of interest to a user based on attributes selected by the user.

FIG. 18 illustrates determining a location of interest based on overlapping areas or zones in accordance with an embodiment.

FIG. 19 illustrates a set of example operations for identifying and presenting social media image content associated with locations of interest.

### DETAILED DESCRIPTION

In the following description, for the purposes of explanation, numerous specific details are set forth to provide a thorough understanding of various implementations. However, embodiments may be practiced without these specific details. In other instances, well-known structures and devices are shown in block diagram form to avoid unnecessarily obscuring the present invention. In some instances, flow diagrams are used to depict steps performed in various implementations. The invention is not limited to the particular order of steps depicted in the figures and the order may vary, depending upon the requirements of a particular implementation. Furthermore, steps that are depicted and described may be removed and/or other steps may be added, depending upon the requirements of a particular implementation. Various aspects are described hereinafter in the following sections:
I. SUMMARY
II. SYSTEM ARCHITECTURE OVERVIEW
III. PERSONALIZATION BY LOCATION ATTRIBUTES
IV. ALLOWING USERS TO ESTABLISH LIMITS ON THEIR DESIRED ATTRIBUTES
IV. CATEGORIZING THE QUALITATIVE AND QUANTITATIVE MEASURES FOR VARIOUS LOCATIONS
V. COMPARING ATTRIBUTE VALUES AGAINST A TYPICAL NORM
VI. ALLOWING USERS TO COMBINE ATTRIBUTES, RESULTING IN A RANKED LIST OF LOCATIONS
VII. INCREASED WEIGHTING OF USER-SELECTED CRITICALLY IMPORTANT ATTRIBUTES
VIII. ALLOWING USERS TO USE DESIRABLE REFERENCE LOCATIONS TO DISCOVER MORE LOCATIONS SHARING THE SAME ATTRIBUTES
IX. RANKING AND DISPLAYING CLOSE MATCHES
X. CATEGORIZING THE QUALITATIVE AND QUANTITATIVE MEASURES AS DESCRIPTORS FOR LOCATIONS
XI. MONETIZING VIA EXPLORATION ENHANCING ADVERTISEMENTS
XII. COMPARATIVELY DISPLAYING THE VALUE RANGES FOR THE VARIOUS ATTRIBUTES VIA HEATMAPS
XIII. ALLOWING USERS TO SELECT FAVORITES
XIV. ISOLATING ATTRIBUTES TO ALLOW DYNAMIC SELECTION OF LIMITS
XV. ALLOWING USERS TO CREATE PROFILES, INCLUDING THEIR RANKED LOCATION LISTS AND FAVORITES
XVI. ALLOW USERS TO “SCORE” AND RANK THEIR CURRENT LIVING LOCATION FOR USE AS A REFERENCE
XVII. ALLOWING USERS TO SHARE THEIR PROFILES
XVIII. SCORING LOCATIONS BY SUBJECTIVE “FEEL” ATTRIBUTES
IXX. PRESENTING SOCIAL MEDIA CONTENT ASSOCIATED WITH LOCATIONS OF INTEREST

### I. Summary

One or more embodiments include a system and architecture for helping users interactively discover and explore personalized locations of interest. In one aspect, the system includes a mechanism for educating users, via an Internet-based system, about the many location attributes users may want to consider when considering locations. For example, a user may be contemplating moving their residence from one location to another. The user may interact with a website to select attributes important to the user and relative rankings for the attributes. A backend system may determine candidate locations based on the user's selections. The system may present candidate locations to the user and provide the user with interface elements to modify selected attributes and rankings, and to obtain additional information about presented candidate locations.

One or more embodiments apply computer models, including one or both of predefined computer algorithms and machine learning models, to user-specified attributes or attributes, values associated with the attributes, and geographic data, such as coordinates and other geographic topographical data to identify one or more geographic locations that correspond to user-selected attributes and values.

In one aspect, the system includes a mechanism that categorizes quantitative data for each location. In one aspect, the quantitative data may be categorized into topics such as arts and entertainment, crime, demographics, politics, weather, and others. In one aspect, the quantitative data categories may be further categorized into subcategories or attributes, such as violent crime, property crime, or homicide.

In one aspect, the system includes a mechanism that categorizes qualitative data for each location. In one aspect, the qualitative data may include images depicting the location. In one aspect, the qualitative data may include hyperlinks to local news and information sources for each location. In one aspect, the qualitative data may include notable facts about the location or notable people associated with the location. In one aspect, the qualitative data may include information about, or links related to, events occurring in the location. In one aspect, the qualitative data may include information about, or links related to, resources or services that may help the user further explore the location.

In one aspect, the system includes a mechanism that displays the range of values for the quantitative data attributes for each location or for all the locations collectively.

In one aspect, the system includes a mechanism allowing users to establish desirable limits on attributes of their choosing.

In one aspect, the system includes a mechanism combining the user's chosen attributes to establish a ranked list of all the locations, the ranking of which depicts those locations that best satisfy the needs and interests of the user.

In one aspect, the system includes a mechanism to present the attribute values in an absolute fashion. In one aspect, the system includes a mechanism to present the attribute values in a relative fashion compared to the typical or average values.

In one aspect, the system includes a mechanism to isolate and display single attributes even when several attributes are selected as important. In one aspect, the isolated attributes may be independently and dynamically modified by the user.

In one aspect, the system includes a mechanism to amplify the weighting of select attributes that are more important than others in the perception of the user. The system re-weights selected attributes and alters the ranking of the various locations based on the re-weighting.

In one aspect, the system includes a mechanism to allow the user to select and isolate favorite locations.

In one aspect, the system includes a mechanism to allow the user to isolate and display locations that completely meet the needs and interests of the user by virtue of those locations being within the limits of the user's selected attributes. In one aspect, the system includes a mechanism to allow the user to display locations that partially meet the needs and interests of the user on a ranked basis in accordance with how well each location meets the needs and interests of the user as identified with how far out of bounds each location's attributes are with respect to the limits established by the user. In one aspect, the system includes a mechanism to reference as “close matches” those locations that are within a specific range of being a complete match.

One or more embodiments determine a geographic location of interest to a user based on a set of user interest criteria. A user provides a set of input data for a set of attributes. For example, a user may interact with a user interface to indicate an importance of the following attributes: distance to a school; quality rating of nearby schools; distance to a transportation point, such as an airport or bus stop; a level of property tax or income tax; geographical attributes, such as ocean, mountains, or forests; distance to recreational opportunities; crime rate; population density; and specified cities, states, or regions. The system may further receive as input data a ranking of two or more attributes. For example, a system may present a user interface with a set of attributes and a set of icons whereby a user may indicate whether an attribute is “somewhat important,” “very important,” or “a deal-breaker.” The system may present a set of user-selected attributes and allow the user to rank the attributes in order of importance.

One or more embodiments determine a strength of an attribute across a geographic zone. The computer model may determine a geographic shape associated with an attribute. The model may further determine a strength of an attribute across the geographic shape. For example, one attribute may be associated with a property tax. The system may identify geographic shapes corresponding to county boundaries. The system may further determine that the magnitude of the attribute is uniform across the respective geographic shapes since the property tax is uniform throughout the respective counties. As another example, the model may determine that a geographic shape associated with an attribute “close to elementary schools” is a circular shape around the elementary school. Alternatively, the system may determine the shape is an irregular shape based on roads that feed into the elementary school and travel times on the roads. The system may further determine that the magnitude of the attribute is high close to the elementary school and decreases with distance towards the boundary of the geographical shape. According to yet another example, the system may determine that a shape is a donut shape. For example, a user may not want to live right next to an airport, but they may want to live within 15-45 minutes of an airport. The system determines the geographic zone associated with the attribute “distance to airport” extends a distance from the airport corresponding to a 15-45 minute travel distance and excludes the region within 15 minutes of the airport.

In one aspect, the system applies a set of predefined rules to user input, including selected attributes and weights and/or rankings associated with the attributes, to determine a location of interest to the user. Additionally, or alternatively, the system may apply a trained machine learning model to the user input data to determine the location of interest to the user.

In one aspect, the system includes a mechanism to allow the user to create a profile that includes their ranked location list and favorite locations. In one aspect, the system includes a mechanism to allow the user to create multiple profiles, each possibly including different location ranks and different favorites based on different selections by the user.

In one aspect, the system includes a mechanism to allow the user to identify their current living location. In one aspect, the system includes a mechanism to score the current living location in accordance with how well said location meets the attributes and limits established by the user. In one aspect, the system includes a mechanism to rank the current living location as compared to all the other locations. In addition, the system may recommend attributes to the user based on user input indicating whether they “love,” “like,” or “dislike” their current location. For example, if a user provides input indicating they “love” their current location, the system may identify attributes associated with the current location, such as low crime, quality schools, and recreational opportunities. The system may recommend these attributes to the user as criteria for identifying alternative locations of interest to the user.

In one aspect, the system includes a mechanism to allow the user to share elements of their profile. In one aspect, the system includes a mechanism to allow the user to share elements of their profile on social media. In one aspect, the system includes a mechanism to allow the user to share elements of their profile via email. In one aspect, the system includes a mechanism to allow the user to share their favorite locations. In one aspect, the system includes a mechanism to allow the user to share their location ranks. In one aspect, the system includes a mechanism to allow the user to share their select attributes and limits.

In one aspect, the system includes a mechanism to allow the user to identify and select multiple reference locations. In one aspect, the system includes a mechanism to compare and correlate all attributes of the reference locations. In one aspect, the system displays the correlation between all the reference locations so that the user can identify common attributes. In one aspect, the system includes a mechanism allowing the user to select the correlated attributes most meaningful to the user. In one aspect, the system includes a mechanism that establishes limits for each of the selected correlated attributes based on the quantitative attribute values of all of the reference locations. In one aspect, the system includes a mechanism that displays all of the other locations that are within the automatically established limits of the selected correlated attributes. In one aspect, the system includes a mechanism that displays all of the “close match” locations in accordance with the description of “close match” mentioned earlier. In one aspect, the system includes a mechanism that displays all of the locations in rank order as established by how well they satisfy the automatically established limits of the selected correlated attributes.

One or more embodiments present a graphical user interface (GUI) that presents locations of interest to users. The GUI displays a set of user input elements to identify (a) an attribute type, (b) an attribute value, and (c) an attribute ranking relative to other attributes. A system applies a location determination engine to the user input data to determine a location of interest. The GUI may display locations of interest in a map. The map may display (a) the location of interest, and (b) one or more locations corresponding to user input attributes. For example, the system may display a map highlighting three different neighborhoods among thousands of neighborhoods in a country. The map may further display the locations of user-selected attributes, such as the location of an airport, the location of recreational opportunities, or a specified location, such as the address of a relative provided by the user.

As users peruse locations of interest, they may be interested to see activities and sights in the vicinity of particular locations. One or more embodiments curate digital image content to present in a GUI based on image content and distance from a location of interest. Digital image content may include videos posted on social media platforms available on the Internet. A system determines a location-of-interest to a user based on a set of attributes selected by a user. The system scrapes websites, such as social media platform websites, to identify a set of candidate digital images. The system determines location data associated with the candidate digital images and activity content associated with the candidate digital images. If the digital images meet content criteria and correspond to locations less than a threshold distance from a location of interest, the system presents the digital image content in a GUI.

For example, a user may select a set of attributes including “hiking,” “close to elementary school,” and “low crime” in a user interface. Based on the user selections, the system identifies three neighborhoods that meet the selected criteria. The system scrapes social media websites to identify images with location data that is within a defined distance of any of the three neighborhoods. The system further analyzes one or both image content and caption content to determine the subject matter of the images. The system presents a set of hiking-related images to a user, together with a location-of-interest identifier, based on determining the hiking-related images were taken within 15 miles of the location-of-interest. Similarly, the system may present an image of an elementary school taken within 15 miles of the location of interest.

One or more embodiments apply a generative artificial intelligence (AI) model to location data to generate subjective rankings for locations. A system obtains a user input specifying a subjective descriptor. For example, a user may generate an input to request recommendations for the most boring, exciting, family-friendly, singles-friendly, senior-friendly, or neighborly city. Alternatively, a user may request a recommendation for cities or neighborhoods with the strongest “hippie vibe” or the most laid-back cities. The user input may specify a subjective attribute, or an attribute that cannot be directly measured. Based on the user input, the system generates a prompt, or set of prompts, for a generative AI model to generate scores for a set of locations, such as a set of cities or neighborhoods. Based on the scores, the system presents to the user a set of one or more cities or neighborhoods that match the user's request for a recommendation.

One or more embodiments determine a location of interest to a user based at least in part on (a) a specified location and (b) a set of travel metrics, including distance to the specified location and mode of transportation to arrive at the specified location. A user selects a geographic location, such as an address of a family member. The user may further select a desired maximum travel time and desired mode(s) of transportation. A system analyzes geographical map data, as well as published travel schedules of public and commercial transportation providers, to determine a set of geographical areas corresponding to the first location. The candidate geographical areas may be separated from each other. For example, if a user specifies a desire to be within five hours of an address by plane, taxi, and/or automobile, the geographical areas may include (a) a first geographical area surrounding the first location and (b) a second geographic area separate from the first geographical area that is within a distance to an airport, such that the travel times by auto, airplane, train, and taxi are less than five hours.

In one or more embodiments, the system generates different travel times to associate with different attributes. For example, a user may select an attribute “close to family,” where the system identifies family as a set of one or more addresses. The system may apply a travel time of 30 minutes as being “close to” family. The user may further select an attribute “close to hospital.” The system may apply a travel time of “5 minutes” as being “close to” the hospital. The system may provide users with the opportunity to adjust travel times for selected attributes. For example, the system may prompt the user to specify how close they would like to be to family, work, recreation, or other potential interests (or wishes) of the user.

When users are searching for a city or neighborhood of interest, such as candidates for buying a home or opening an office, the user may be interested in not just measurable metrics, such as distances to schools or crime statistics, but also more subjective metrics, such as a neighborhood's personality. One or more embodiments apply a generative AI model to census tract data to generate city or neighborhood personality descriptions. A system generates a generative AI prompt including (a) a set of neighborhood personality labels and (b) a set of city or census tract data. The neighborhood personality labels specify different neighborhood personality categories. Based on the output from the generative AI model, the system generates a ranking of census tracts or neighborhoods for respective personality labels. For example, neighborhood personality labels may specify an “atmosphere and energy” of a neighborhood, such as “laid-back beach vibe” or “playful and quirky.” Other neighborhood personality labels may include a cultural feel of a neighborhood, such as “historic” or “eclectic.” Census tracts define neighborhoods as discrete geographic units. As a result, as users peruse neighborhoods in a graphical user interface (GUI), the system utilizes generative AI models to provide users with descriptions of neighborhoods' personalities.

One or more embodiments generate reports for users based on user-selected attributes and/or based on identified locations of interest to the user. For example, once a user has identified a location of interest based on user-selected criteria, the system may present in a GUI selectable interface element. Selecting the interface element may cause the system to present to the user a “dirty laundry report,” or a report of potentially negative aspects of the location that may not have been represented in the user's selected attributes. For example, a user may select vicinity to schools, to a relative's home, and low crime as important criteria for identifying a location of interest. The dirty laundry report may identify relatively high property taxes, extreme allergy seasons, extreme weather, and a distance from shopping as potential negative attributes of the location that the user may want to consider.

As another example, the system may present a selectable user interface element for presenting a “delta report.” A delta report highlights differences between two locations. For example, a user may provide their current location. The system may identify a location of interest based on a set of attributes selected by the user. The system may generate the delta report to identify attributes that differ from the user's current location, including attributes that the user may not have selected as attributes to be considered when determining the location of interest.

According to yet another example, the system may present a selectable user interface element for presenting a “convince me” report. The “convince me” report may highlight positive aspects of a location of interest. For example, a user may direct the system to share a “convince me” report with the user's spouse. The user may have selected one set of attributes for generating the location of interest. The system may identify additional attributes from the spouse's profile that are selected as being important to the spouse. The system may generate the “convince me” report for the spouse by highlighting the attributes important to the spouse, rather than the attributes important to the user.

### II. System Architecture Over View

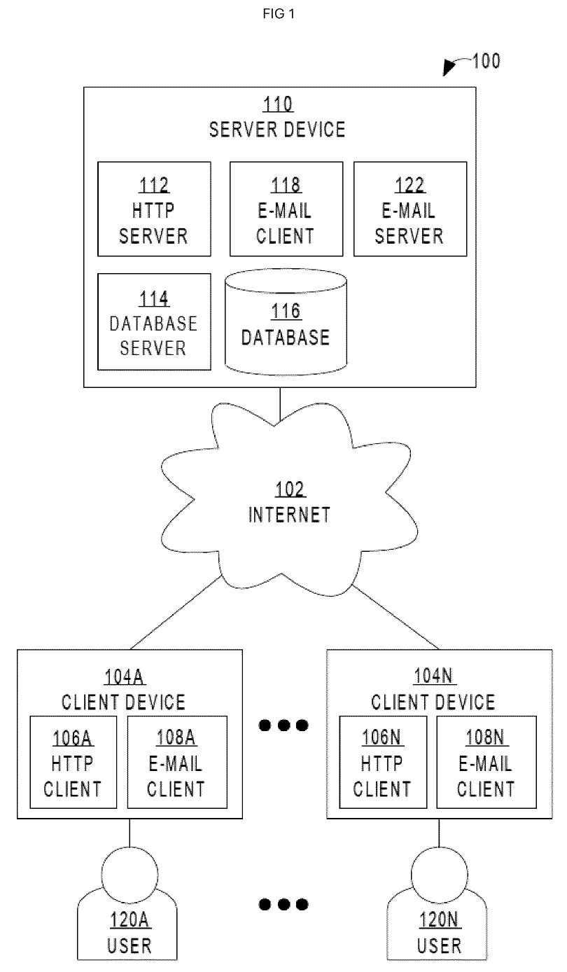

FIG. 1 is a block diagram that depicts a system for helping users interactively discover and explore ideal personalized locations, in accordance with an implementation. System 100 includes the Internet 102, client devices 104A-N, and server device 110. Client devices 104A-N are coupled communicatively with Internet 102. Server device 110 also is coupled communicatively with Internet 102. Client devices 104A-N include Hypertext Transfer Protocol (HTTP) clients 106A-N, respectively, and e-mail clients 106A-N, respectively. Server device 110 includes HTTP server 112, database server 114, database 116, and e-mail client 118.

Users 120A-N are individual people who use client devices 104A-N, respectively, to send information to and receive information from server device 110. Client devices 104A-N are devices that are configured to interface with both a human being and Internet 102. For example, client devices 104A-N may include general-purpose computers, workstations, laptop computers, tablet computing devices, mobile devices including mobile phones, Internet appliances, etc.

HTTP clients 106A-N execute on the client devices 104A-N and are configured to send HTTP requests and receive HTTP responses. Example implementations of the HTTP clients 106A-N include, without limitation, Web browsers and application programs, also known as “apps.” HTTP clients 106A-N receive information from users 120A-N, respectively, and generate and send the information in the form of HTTP requests to HTTP server 112. HTTP clients 106A-N receive HTTP responses from HTTP server 112 and provide some or all of the information contained in such HTTP responses to users 120A-N, respectively. HTTP clients 106A-N send HTTP requests and receive HTTP responses through Internet 102. One example implementation is an application program executing on a mobile device, such as a mobile phone, that provides a graphical user interface for displaying information to users and receiving user inputs, and that also includes HTTP capability to communicate with the HTTP server 112. Although implementations are depicted in the figures and described herein in the context of HTTP, this is done for explanation purposes and implementations are not limited to the HTTP and are applicable to other protocols.

E-mail clients 108A-N are programs that are configured to send and receive e-mail messages according to any protocol. Example protocols include, without limitation, POP3, SMTP, and IMAP. For example, e-mail clients 108A-N may include Microsoft Outlook. E-mail clients 108A-N receive information from users 120A-N, respectively, and send that information in the form of e-mail messages to an e-mail server. E-mail clients 108A-N receive e-mail messages from e-mail servers and provide some or all of the information contained in such e-mail messages to users 120A-N, respectively. E-mail clients send and receive e-mail messages through Internet 102.

Like client devices 104A-N, server device 110 is a device that is configured to interface with Internet 102. For example, server device 110 may be a general-purpose computer. HTTP server 112 is a program that is configured to receive HTTP requests and send HTTP responses. HTTP server 112 is also called a “web server.” HTTP server 112 receives HTTP requests from HTTP clients 106A-N through Internet 102. HTTP server 112 sends HTTP responses to HTTP clients 106A-N through Internet 102.

HTTP server 112 may interface with a variety of programs that reside on server device 110. HTTP server 112 may send, to such programs, information received in HTTP requests. Similarly, HTTP server 112 may receive, from such programs, information that HTTP server 112 then sends in HTTP responses.

Database server 114 is a program that is configured to receive database commands from programs resident on server device 110. Database server 114 also is configured to execute such database commands to store data in, modify data in, or retrieve data from database 116. Database server 114 also is configured to send retrieved data to programs resident on server device 110. For example, database commands may take the form of Structured Query Language (SQL) statements. Database server 114 may select, from database 116, data that satisfies criteria specified in such SQL statements.

E-mail client 118 is similar to e-mail clients 108A-N in that e-mail client 118 also is a program that are configured to send and receive e-mail messages according to an e-mail protocol. E-mail client 118 receives information from programs resident on server device 110, and sends that information in the form of e-mail messages to an e-mail server. E-mail client 118 receives e-mail messages from an e-mail server and provides some or all of the information contained in such e-mail messages to programs resident on server device 110.

Database 116 stores information about user accounts. Each of users 120A-N may be associated with one or more user accounts. Among other information, each account may be associated with a separate username and password. For each account, database 116 stores a separate set of information items that are associated with that account. The set of information items associated with a particular account may vary depending on the account's account type.

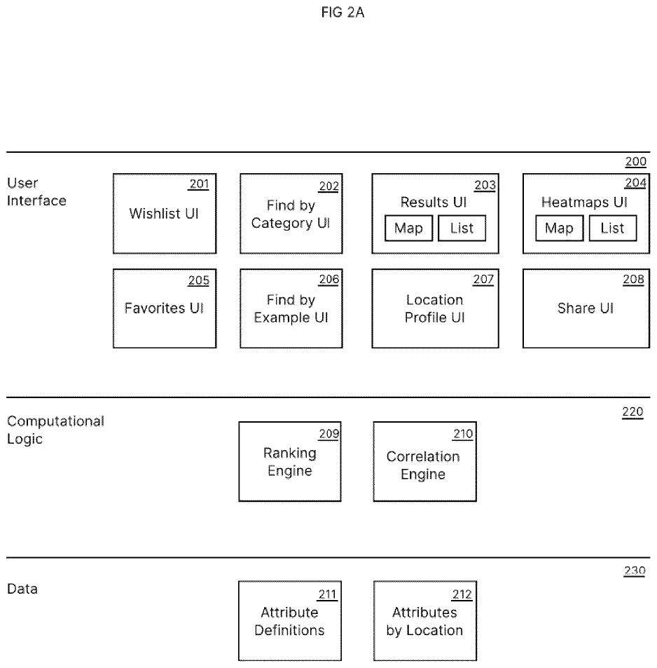

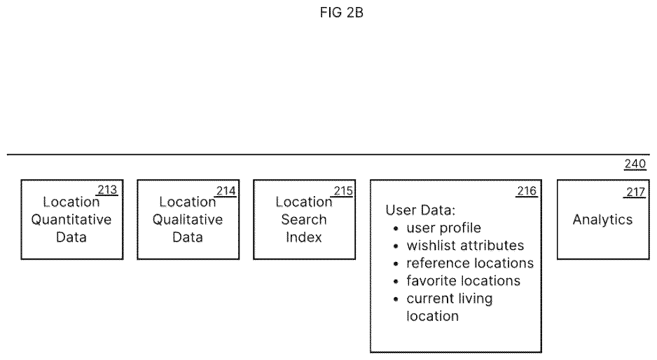

FIG. 2A is a block diagram that depicts a set of system architecture front-end application components, in accordance with an implementation.

User Interface (UI) 200 includes the Wishlist UI 201, Find by Category UI 202, Results UI 203, Heatmaps UI 204, Favorites UI 205, Find by Example UI 206, Location Profile UI 207, and Share UI 208. Wishlist UI 201, Find by Category UI 202, Results UI 203, Heatmaps UI 204, Favorites UI 205, Find by Example UI 206, Location Profile UI 207, and Share UI 208 may be presented as selectable interface elements in a GUI. For example, a GUI may present a “Wishlist” panel that includes a set of attributes identified by a user as being important to the user when searching for a location. A Find by Category UI 202 may be presented as a drop-down menu or a selectable list of attributes that are organized by category, such as “recreation,” “transportation,” “demographics,” and “vibe.” A Results UI 203 may present locations of interest, as determined by the ranking engine 209 and/or the correlation engine 210, based on a user's selected attributes as a list of locations and/or as icons on a map. The Heatmaps UI 204 may specify multiple different locations based on the degree of matching location attributes with a user's selected attributes. For example, if a Heatmap UI 204 is displayed on a map in a GUI, the Heatmap UI 204 may include a first location, such as a neighborhood, that has a high correlation between neighborhood attributes and a user's selected attributes. The first location may be displayed in a first color or shade. The map may display surrounding neighborhoods in another color or shade, representing a high correlation that is less than that of the first location. The map may further display additional surrounding in another color or shade, representing a medium correlation that is less than that of the first set of surrounding neighborhoods.

A Favorites UI 205 displays a set of locations selected by a user as being a “favorite.” The system may maintain the set of locations in the Favorites UI 205, even while the user performs various searches selecting varying attributes. The Find by Example UI 206 provides an interface that allows a user to provide an example location. The system identifies additional candidate locations based on the attributes of the example location. The Location Profile UI 207 displays information about selected locations and/or locations of interest identified by the system based on user-selected attributes. The Share UI 208 presents an interface element to share a location of interest with one or more additional users. The Share UI 208 may further include selectable options to share selected attributes and/or reports with additional users.

Computational Logic 220 includes the Ranking Engine 209, and Correlation Engine 210. The Ranking Engine 209 implements an algorithm that uses information from a user's Wishlist and information describing location attributes to determine a set of locations that match the attributes in the user's Wishlist. The Correlation Engine 210 analyzes matches identified by the Ranking Engine 209 to identify a subset of matches that have the highest relevancy to a user based on locations in which the user has expressed an interest.

The Data Layer 230 includes the Attribute Definitions 211, and Attributes by Location dataset 212. Attribute definitions 211 specify the minimum attribute value, maximum attribute value, and attribute value correlation across locations. Attributes by Location dataset 212 specify attributes associated with locations and is comprised of various locations, each containing the wishlist attributes unique to each location. For example, Attributes by Location dataset 212 may include, for a particular location, data specifying that an elementary school is within 0.25 miles of the location, recreation-type locations are within. 5 miles of the location, night-life-type locations are within 20 miles of the location, hiking trails are within 0.25 miles of the location, and an airport is within 60 miles of the location.

FIG. 2B is a block diagram that depicts a set of system architecture server components, in accordance with an implementation.

Server Components 240 includes the Location Quantitative Data 213, Location Qualitative Data 214, Location Search Index 215, User Data 216, and Analytics 217. Location Qualitative Data 214 includes images depicting the location, hyperlinks to local news and information sources for each location, notable facts about the location or notable people associated with the location, information about, or links related to, events occurring in the location, and information about, or links related to, resources or services that may help a user explore a location.

Location Search Index 215 includes cross-references of all neighborhood names, census tracts, cities/towns, zip codes, counties, and states. This allows the system to correlate any dataset to the corresponding locations and allows users to search for any of these locations by name or number.

User Data 216 includes the User Profile, the Wishlist, the Reference Locations, the Favorites Locations, and the Current Living Location. User Data 216 may be associated with a username that is unique among usernames stored in database 116. User Data 216 may be associated with a set of information items including user profile, Wishlist attributes, reference locations, favorite locations, and current living location.

Analytics 217 includes administrator-only data related to the aggregated user base. It may include such data as visitor counts, favorites counts, user home locations, most commonly selected Wishlist categories (e.g., weather, crime, geography, demographics, etc.), most commonly selected Wishlist attributes (e.g., political orientation, violent crime, hiking, median home price, etc.), feature popularity, etc.

Different user accounts may be associated with separate sets of such information items. For example, a first user account may be associated with a first set of Wishlist attributes, and a second, separate user account may be associated with a second, separate set of Wishlist attributes.

Information items described above may be used in interactions between components of system 100. Examples of such components using these information items are described in further detail below.

FIG. 5 is a flow diagram that depicts an approach for enhancing system performance and reducing latency that could impact the user's experience, in accordance with an implementation. A front-end application 511 interacts with a server 512 to access data from the server 512 and present the data in a user interface 501 or 506. The server 512 may correspond to the server 110 in FIG. 1. The front-end application 511 may include hardware and software to implement the user interface 200 and computational logic 220 of FIG. 2A, for example.

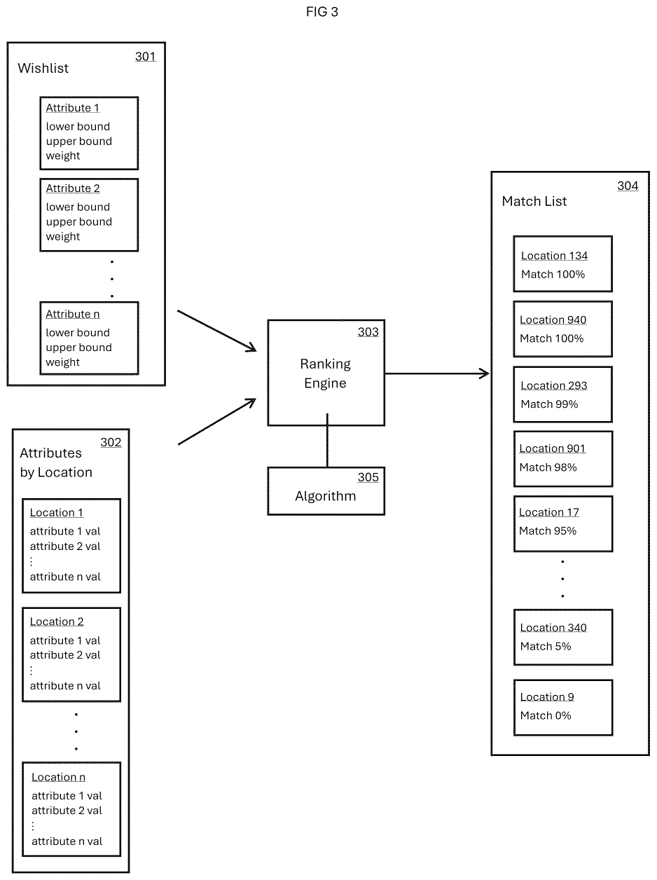

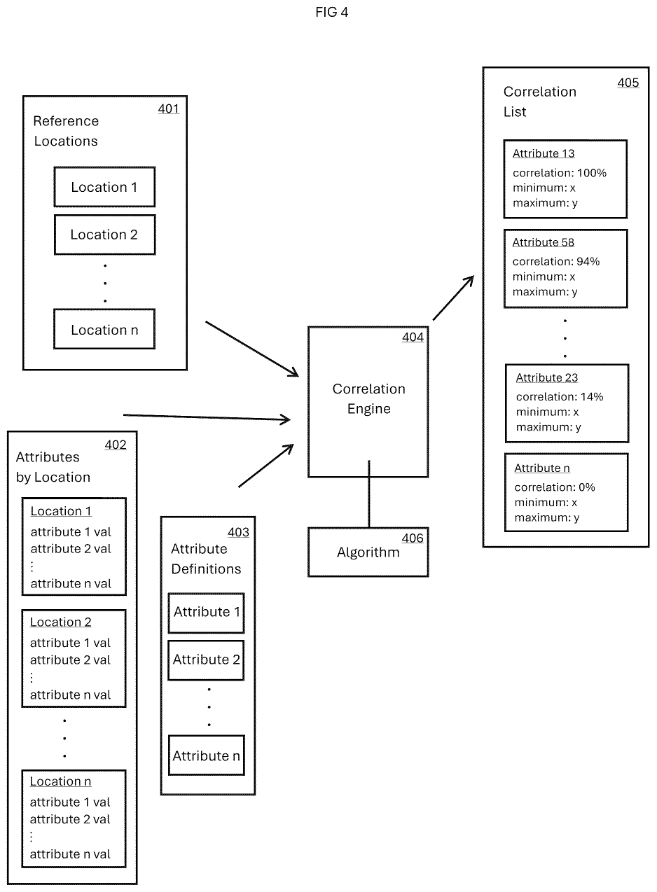

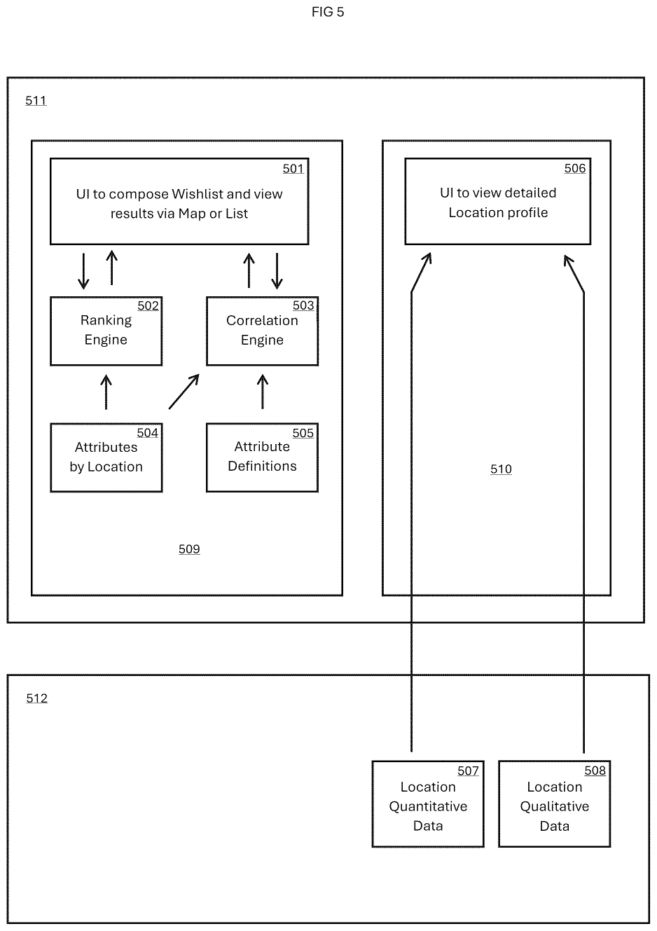

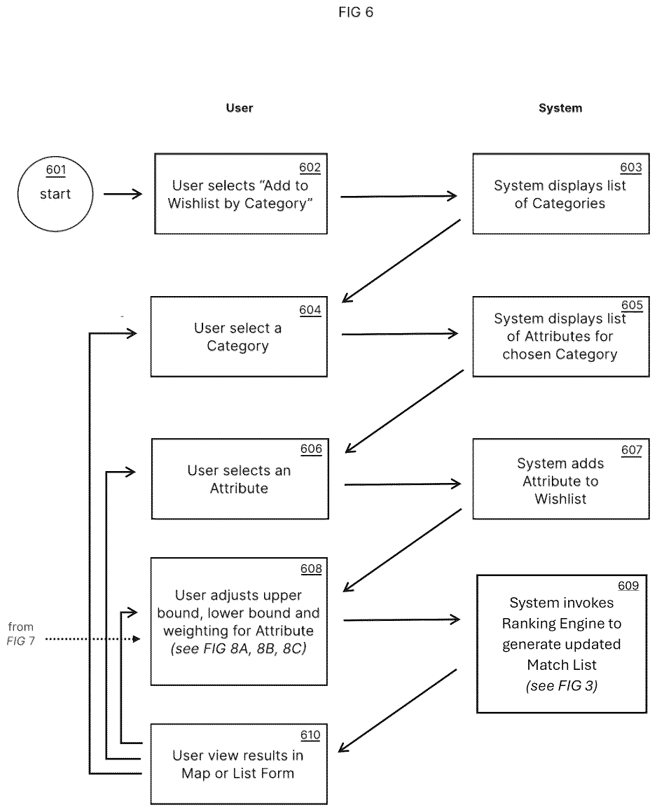

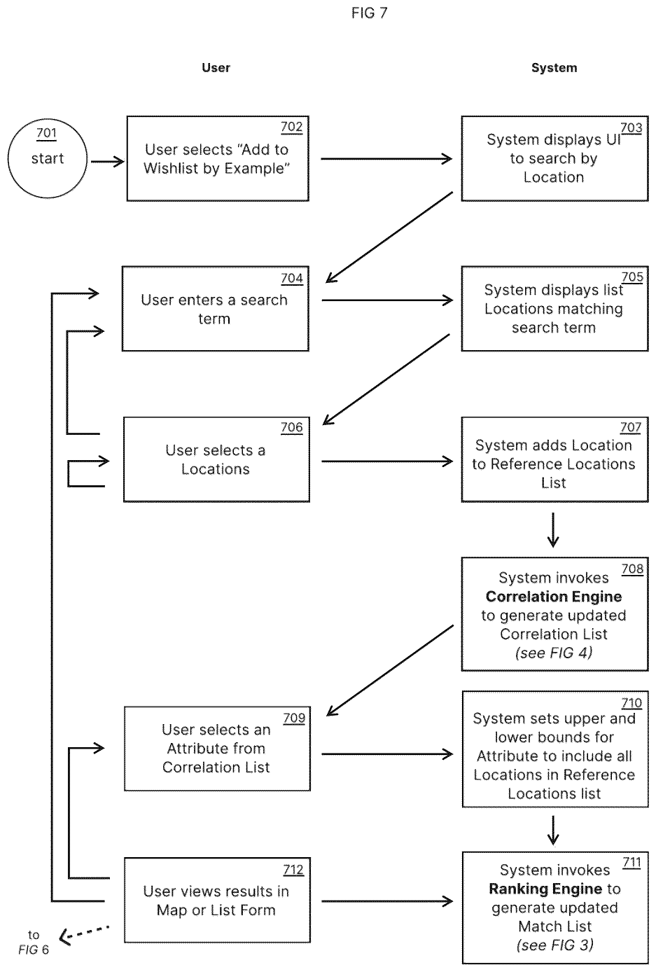

The front-end application 511 performs calculations and operations to generate and present in a UI 501 the Wishlist, map, or list of candidate locations. The operations of the ranking engine 502 and correlation engine 503 are performed by the front-end application 511. The ranking engine 502 corresponds to the ranking engine 209 of FIG. 2A and the ranking engine 303 of FIG. 3. The correlation engine 503 corresponds to the correlation engine 210 of FIG. 2A and the correlation engine 404 of FIG. 4.

The front-end application 511 further stores attributes by location 504 and attribute definitions 505. The Attributes by Location dataset 504 data corresponds to the Attributes by Location dataset 212 illustrated in FIG. 2A. The Attribute Definitions 505 corresponds to the Attribute Definitions 211 illustrated in FIG. 2A. Performing ranking and correlation functions improves application performance by eliminating latency that would be introduced by relying on server 512 to perform these functions. The system utilizes server 512 to perform and manage less frequent interactions, such as presenting a UI 506 to view detailed location profiles. The system may retrieve location profile data from the server 512 “just in time” for display, eliminating excessive data storage requirements in the front-end application 511 that would degrade its startup time, especially over slower network connections. The UI to view detailed location profiles 506 is comprised of Location Quantitative Data 507 and Location Qualitative Data 508, both of which are stored on the server.

### III. Personalization by Location Attributes

FIG. 3 is a flow diagram that depicts an approach for ranking locations based on user selection of important location attributes, in accordance with an implementation.

The Wishlist 301 is comprised of various location attributes grouped into various categories. Attributes may include characteristics, such as a lower bound, an upper bound, and a weight. For example, lower and upper bound may correspond to a distance from a location characterized by the attribute or an amount of an attribute associated with a location. The weight may represent a relative value a user places on an attribute. The user may have two attributes on a Wishlist. One may have a higher weight than the other. The ranking engine 303 generates a stronger match percentage for locations associated with the attribute with the higher weight.

An example, non-exhaustive, list of attributes follows:
Activities: boating, cycling, fishing, golf, hiking, hunting, national parks, rock & mountain climbing, skiing
Arts & Entertainment: art museums, history museums, live music, performing arts, regional theater
Crime: gang presence, homicide rate, property crime rate, violent crime rate Demographics: median age, ethnicity/race (American Indians/Alaskan natives, Asian Americans, blacks/African Americans, Hispanics/Latinos, multiracials, native Hawaiians/pacific islanders, whites), households (same sex households, single parent households), language spoken at home (Asian language speakers, English speakers, Indo-European language speakers, other language speakers, Spanish speakers), population by age (people 0-9 years old, people 10-19 years old, people 20-29 years old, people 30-39 years old, people 40-49 years old, people 50-59 years old, people 60-69 years old, people 70-79 years old, people 80+ years old)
Dining: alcohol (craft breweries, wineries), cuisine diversity, farmers markets, Michelin-rated restaurants

Economics: median income, affordability (income/expenses), typical expenses, homelessness, poverty rate, public assistance, unemployment rate, financial relocation incentives, other relocation incentives
Education: ACT/SAT scores, educational attainment, high school graduation rate, school rating
Environment: air quality, water quality
Friends & Family: drive time to locations, flight time to locations
Geography & Nature: elevation, forests, freshwater access, mountains, scenic beauty, seacoast proximity
Grab Bag (Miscellaneous): broadband internet, happiness, meth labs, nuclear strike risk
Health & Medical: healthcare services (primary care physicians, mental health providers, dentists, hospitals), lifestyle (life expectancy, obesity rate, smokers)
Housing: buying (median home price, home ownership rate, investment potential), renting (median rental price, cat friendly rentals, dog friendly rentals)
Natural Disasters: any natural disaster, avalanche, coastal flooding, cold wave, drought, earthquakes, hail, heat wave, hurricanes, ice storms, landslide, lightning, river flooding, strong wind, tornadoes, tsunami, volcanic activity, wildfires, winter weather
Pests & Wildlife: fire ants, mosquitos, shark attacks, termite infestation, venomous snakes Politics: political orientation
Population: major city proximity, city population, county population, population density, population growth
Religion: Buddhists, Catholics, Hindus, Jehovah's Witnesses, Jews, LDS/Mormons,
Muslims, not religious/atheists/agnostics, Orthodox Christians, other Christians (e.g., Amish, Mennonite), Protestants/Non-Denominational
Rights & Freedoms: abortion regulation, alcohol regulation, cannabis regulation, gun regulation, private/home school regulation, tobacco regulation
Sports: Major League Baseball (MLB), Major League Soccer (MLS), Minor League Baseball (MiLB), NBA basketball, NFL football, NHL hockey, NCAA baseball, NCAA basketball, NCAA football, NCAA hockey, NCAA soccer
Taxes: property tax rate, sales tax rate, state income tax rate
Transportation: airport proximity (major airport, small or major airport, any airport), automobiles (commute time, electric vehicle chargers, gasoline prices, traffic), other transportation (bike commuters, mass transit, walkability)
Weather: precipitation (rain, snow, sunny days), temperature (seasons, summer heat, summer mugginess, winter cold), other (windiness)

Some Wishlist attributes may be variable, dependent on the user's family size and number of income earners. The UI will make provision to collect this information from the user, in accordance with an implementation.

FIG. 6 is a flow diagram that depicts a workflow approach for Finding Matches by selecting Category Attributes, in accordance with an implementation. The Wishlist 301 may be presented in the Wishlist UI 201 illustrated in FIG. 2A. The Attributes by Location dataset 302 corresponds to the Attributes by Location dataset 212 illustrated in FIG. 2A. The Ranking Engine 303 corresponds to the Ranking Engine 209 illustrated in FIG. 2A.

In block 602, user takes an action signifying interest in adding a location attribute to their Wishlist 301.

In block 603, system displays a list of categories from which the user can select. As described earlier, the categories may include topics such as crime, politics, and weather.

In block 604, user selects a single category, which prompts the system to display the list of attributes for the selected category 605. The user may only select one category at a time, but may later select additional categories, again, one at a time.

In block 606, user selects a single location attribute to be added to user's Wishlist 301. User may then select and add additional location attributes to be added to the user's Wishlist 301.

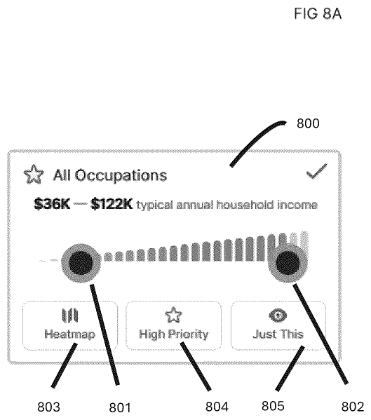

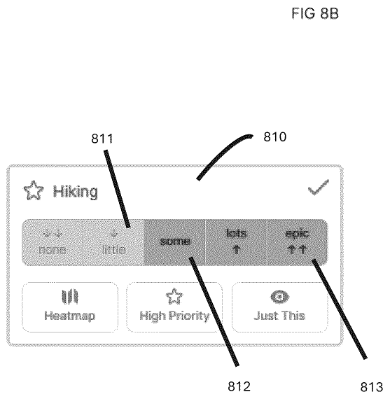

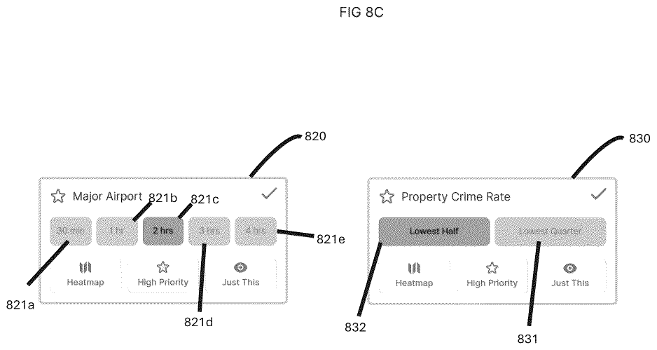

In block 608, user may adjust an upper bound, lower bound, or weighting (see FIGS. 8A, 8B, and 8C) for each location attribute in the Wishlist 301.

In block 609, system invokes the Ranking Engine (see FIG. 3) to generate or update the Location Match List 304. The Ranking Engine 303 applies the algorithm 305 to determine percentage matches based on (a) attributes in the user's Wishlist 301, (b) bounds identified for the attributes, (c) weights identified for the attributes, (d) attributes associated with locations as stored in the Attributes by Location Dataset 302, and (e) attribute values associated with the locations.

In block 610, system displays the Match List 304 in map or list form.

User may continue to add 604 or remove categories, add 606 or remove attributes, or adjust attribute bounds and weightings until they are satisfied.

People have wishes, but they don't realize the wishes are geographically based. For example, people often say they want low crime, shopping access, golf, nightlife, hiking, dining options, access to skiing, etc. But they don't necessarily want all of them right in their neighborhood. They will want low crime where their residence is, but don't necessarily want nightlife or skiing in their neighborhood too.

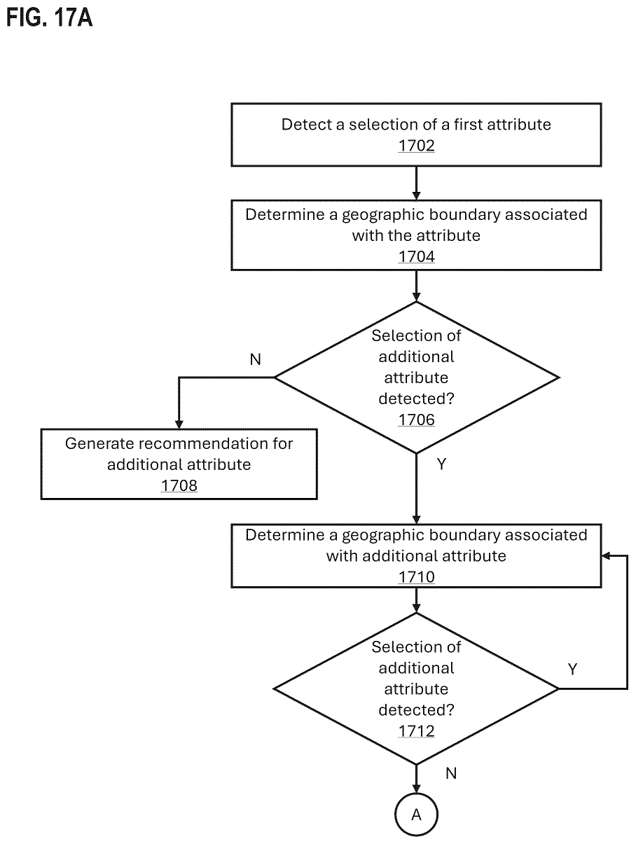

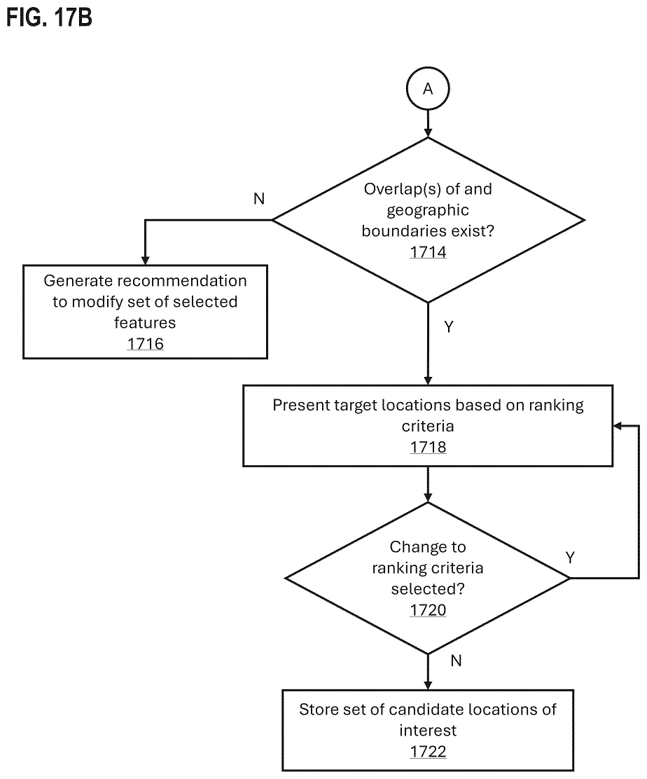

In one or more embodiments, a system identifies locations of interest to a user based on identifying locations that fall within overlapping regions associated with attributes selected by the user. FIGS. 17A and 17B illustrate an example set of operations for identifying locations of interest to a user based on attributes selected by the user.

A system detects the selection of a first attribute (Operation 1702). For example, a system may present sets of selectable attributes in a GUI, and a user may select one or more of the attributes. As another example, a user may enter a name for an attribute in a text entry field.

The system determines a geographic boundary associated with the attribute (Operation 1704). Determining the geographic boundary may include, for example, determining a shape of the geographic boundary and determining a size of the geographic boundary. According to one example, the shape of the geographic boundary is a regular geometric shape, such as a circle. For example, a user may select an attribute “High School” and a criterion “within 5 minutes.” The system may identify high schools and generate a circle around the high schools representing a 5-minute travel time.

According to another example, the shape of the geographic boundary is an irregular geometric shape. For example, the user may select the attribute “High School” and a criterion “within 15 minutes walking.” The system may identify walking routes from the high school and may generate an irregular geometric boundary around the high school based on the walking routes.

According to yet another example, the shape of the geographic boundary may be based on predefined boundaries, such as a city or state border. For example, the user may select an attribute “income taxes” and specify a criterion “none.” The system may generate a boundary that corresponds to the borders of states that have no income taxes. In an example embodiment, the geographic boundary may have a “donut-like” shape, or a shape that omits a portion around a candidate location of interest and includes a portion farther outward. For example, the system may generate a geographic boundary around an airport (where “Airport” is the selected attribute) that excludes a region within five miles of the airport and includes the region between five to thirty miles of the airport.

In one embodiment, the system applies geographic boundaries to locations that correspond to a selected attribute. For example, if the selected attribute is “night life” the system may apply a geographic boundary to clubs and restaurants in a downtown area of a city. If the selected attribute is “crime,” the system may apply the geographic boundary to neighborhoods or cities that match a corresponding crime criterion. If the selected attribute is “beaches,” the system may apply the geographic boundary to geographic features on a map identified as beaches.

In an alternative embodiment, the system applies the geographic boundary boundaries to target locations, such as neighborhoods, census tracts, or even individual residences. For example, if a criterion selected for “nightlife” is “within 20 minutes' drive,” the system may determine a geographic boundary for a set of target locations that corresponds to a 20-minute drive. The system determines if the user's wish is met based on determining if a “nightlife” location (such as a club, restaurant, or theater) is within the 20-minute drive boundary. As another example, if a criterion selected for “sister's home (with an address)” is “within 4 hours flying,” the system may determine a geographic boundary that includes (a) travel time from a target location to an airport, (b) wait time at the airport, (c) flight time to an airport in the vicinity of the address identified as “sister's home,” and (d) travel time to the address identified as “sister's home.” The system may identify a set of target locations that meet the criterion “within 4 hours flying” to “sister's home” based on determining the address corresponding to “sister's home” is within the geographic boundary.

In one or more embodiments, the system determines the geographic boundary based at least on a ranking, a distance, a transportation type, and an attribute type. The ranking, distance, transportation type, and attribute type may be values selected by a user and/or values calculated or determined by the system. According to one example, the system determines the geographic boundary based on the ranking value assigned to the attribute by reducing a size of the geographic boundary based on increasing a ranking value. For example, if a user selects an interface element to indicate a vicinity to a school is “very important,” the system may increase the ranking value associated with the attribute “school” and reduce the geographic boundary, representing a desire that a candidate location of interest be closer to a school.

In one or more embodiments, the size of the geographic boundary may be based on a magnitude value associated with an attribute. For example, an attribute “National Park” may have a greater magnitude value than “playground.” Accordingly, the system may generate a larger geographic area associated with the criterion “close to National Park” compared to the criterion “close to playground.”

In one or more embodiments, the geographic boundary is based on a mode of transportation. The mode of transportation may be selected by a user in a GUI. For example, if a target location is a particular census tract, the system may generate a geographic boundary of one size based on a selection of a “car” mode of transportation. The system may generate a geographic boundary of another size based on selections of “walking,” “train,” “commercial bus,” or “commercial airline,” respectively. For example, a user may select an attribute “hiking” and criteria “within 10 minutes' drive.” The system generates geographic boundaries that correspond to 10-minute drives from candidate geographic locations, such as census tracts.

In some embodiments, the system generates a set of non-contiguous geographic boundaries associated with a particular attribute. For example, a user may select criteria “4 hours by commercial airline” associated with an attribute (such as an address of a family member). The system may determine a geographic boundary by identifying (a) a first sub-area associated with travel time to/from a first airport associated with a candidate location, and (b) a second sub-area associated with travel time to/from a second airport associated with the attribute.

In some embodiments, the system generates geographic boundaries based on multiple different types of modes of travel. For example, the system may determine a geographic boundary based on a travel time to use a public or commercial transport service, such as a bus, train, or airplane, and to travel to a transportation hub associated with the service. The travel to the transportation hub may be based on one type of transport, such as a commercial taxi service, personal car, or bicycle.

In one or more embodiments, a system determines a magnitude associated with a selected attribute. The geographic boundary may be based on the magnitude. In some embodiments, the system determines a rate of decay of the attribute within the geographic area defined by the geographic boundary. For example, if an attribute is “tax rate,” then the magnitude of the attribute may be uniform within a political boundary, such as a city boundary or a state boundary. If the attribute corresponds to “property crime rate,” the magnitude associated with the attribute may be greater near a location associated with a high property crime rate, and the magnitude may decay, or decrease with distance, the farther from the location associated with the high property crime rate. The system may determine the geographic boundary based on determining a magnitude associated with the attribute meets a threshold value. For example, the system may assign a magnitude of 100 to a location with a high property crime rate. The system may apply an algorithm to decrease the magnitude by 10 for every mile extending away from the location. The system may generate the geographic boundary around the location where the magnitude reaches a value of 30 (e.g., 7 miles away from the location).

The system determines if a user has selected an additional attribute (Operation 1706). If not, the system generates a recommendation for an additional attribute to select (Operation 1708). For example, the system may generate a recommendation based on the user's profile data and/or the user's current location. In an embodiment, the system determines whether to generate the recommendation for the additional attribute based on a number of candidate locations associated with the previously-selected attribute. For example, if a number of candidate locations exceeds a threshold, such as 30 locations, the system may recommend one or more additional attributes to narrow down the set of candidate locations.

If the system determines the user has selected an additional attribute, the system determines the geographic boundary associated with the additional attribute (Operation 1710).

The system again determines if a user has selected an additional attribute (Operation 1712). The system repeats the process of determining geographic boundaries associated with additionally-selected attributes until the system determines the geographic boundaries have been determined for each selected attribute.

The system determines if an overlap exists for the geographic boundaries associated with selected attributes (Operation 1714). In an embodiment, the system determines locations associated with attributes, generates geographic boundaries based on the locations associated with the attributes, and determines an overlap region among the geographic boundaries associated with the attributes. Based on the overlap region, the system identifies candidate locations of interest to a user, such as neighborhoods, residences, and/or census tracts that are location within the overlap regions.

In another embodiment, the system begins with a broad set of potential locations of interest, such as every census tract in the United States. The system narrows down the broad set of locations of interest based on generating geographic boundaries that are associated with the locations of interest. For example, a system may generate a first geographic boundary based on the criteria “15-minute drive from a hospital,” and a second geographic boundary based on the criteria “public schools in top 20% nationwide.” The first geographic boundary may be measured by a distance from a location. The second geographic boundary may be defined by geographic boundaries of school districts. The system narrows down the broad set of locations to a first subset based on determining whether a hospital is within the first geographic boundary of the set of locations. The system further narrows down the subset of locations to a subset of candidate locations based on determining the candidate locations meet the criteria of public schools being in the top 20% nationwide.

In an embodiment, the system determines whether an overlap exists based on applying a logical OR function to at least two selected attributes and/or criteria. A user may select multiple attributes. Instead of finding an overlap of geographical boundaries for each attribute, the system may identify overlaps among any of the attributes designated with an “OR” operand.

If the system determines an overlap does not exist in the geographic boundaries corresponding to selected attributes, the system generates a recommendation to modify a set of selected attributes (Operation 1716). For example, the system may recommend removing a selected attribute, replacing a selected attribute with a substitute attribute, and/or modifying a criteria associated with a selected attribute.

For example, the system may recommend a user change a criteria “Beachfront” to “within a 10-minute walk to a beach.” The system may recommend a user change an attribute “Oceanfront” to “Waterfront.” The system may recommend a user remove a criteria “average housing price less than $250,000.”

If the system determines that an overlap exists among the geographic boundaries for the various attributes selected by a user, the system presents a set of target locations based on a set of ranking criteria (Operation 1718). For example, if a set of selected attributes includes the “Hiking” attribute with a criteria “within 15 minutes,” and if the user indicated the “Hiking” attribute is “Very Important,” relative to other selected attributes, the system may rank a first location higher than a second location, where the first location and the second location both exist in overlap regions of various selected attributes, and where the first location is closer to hiking trails than the second location.

The system determines if a user has modified a set of ranking criteria (Operation 1720). For example, the system may detect a user's selection of one or more interface elements in a GUI displaying a set of candidate locations. The interface elements may cause the system to store different ranking criteria, such as a change of importance of one attribute relative to another.

If the system determines no change has been made to ranking criteria, the system stores the set of candidate locations of interest (Operation 1722). For example, the system may associate various searches performed by a user by selecting attributes and criteria with a user's profile.

In one example, a user may select a first attribute, a desired travel time to the attribute using a mode of transportation, and an importance of the attribute to the user. The system generates a first set of candidate locations by generating a set of geographic boundaries around the geographic locations based on the user selections. For example, if the user selects “within 15-minute drive of hiking” and designates a high level of importance, the system generates a set of geographic boundaries associated with a 15-minute drive. The system determines the first set of candidate locations based on determining “hiking” is within a 15-minute drive of the locations. For example, the system may identify trailheads within the 15-minute drive of the candidate locations. The system omits from the set of candidate locations any location that does not include “hiking” within the 15-minute drive. The user may further select a qualitative value associated with the attribute. For example, a GUI may include icons indicating “epic,” “scenic,” “moderate,” and “easy.” If the user selects “moderate,” the system may further determine whether the hiking within the 15 minute drive includes “moderate”-type trails. The system may define the difficulty of the trails based on distance, elevation gain, or other criteria, such as user ratings on social media platforms. The system may further filter the set of candidate locations based on the user's qualitative selection.

The system may detect the user selection of another attribute and criteria, such as “within 10-minute walk of elementary school.” The system generates a second set of geographic boundaries associated with the second selection based on determining a distance associated with a 10-minute walk. The system determines a set of locations that have an elementary school within a distance corresponding to a 10 minute walk.

The system determines whether any of the candidate locations associated with the first attribute, hiking, overlap the candidate locations associated with the second attribute, elementary schools. The system may present any locations that are associated with both attributes to a user in a GUI. The system may order or rank the locations presented to the user based on user-specified ranking criteria. For example, if the user specifies that hiking is extremely important and vicinity to schools is only moderately important, the system may present locations that are closer to hiking higher on a list of candidate locations than locations that are closer to elementary schools.

If the system determines the user selects an additional attribute, the system repeats the process to generate a new set of geographic boundaries and potentially a smaller set of candidate locations. For example, the user may select an attribute “low property taxes.” The system may identify a set of geographic boundaries that correspond to cities and counties that have property taxes in the bottom 20% of cities and counties in a country. The system may determine if any locations meet all three user-selected attributes and criteria-vicinity to hiking, vicinity to elementary schools, and low property taxes. If so, the system presents a corresponding set of candidate locations, ranked according to a user's indicated priorities.

According to one embodiment, a user may select an address or neighborhood as an attribute. For example, the user may provide the system with a set of addresses corresponding to friends and/or family members. Addresses may include street numbers, street names, cities, counties, and states. In some implementations, a user may omit a street number or a street name.

In some implementations, the user enters a quantitative value associated with an address, such as a set of distance bounds. The user may specify a lower bound of “20-minute drive” and an upper bound of “2-hour drive,” indicating the user does not wish to be within a 20-minute drive of the address, but does not want to be outside a 2-hour drive of the address. Additionally, or alternatively, the system may provide the user with interface elements to apply a ranking score to specified addresses. The system may designate a criterion of “5-minutes' drive” for a ranking score of 3 and a criterion of “2 hours any transport” for a ranking score of 1. Additionally, or alternatively, a system may generate bounds based on a specified relationship or importance. For example, the system may generate a default upper bound of “15-minute drive” for a parent relationship and a default upper bound of “1.5-hour drive” for a sibling relationship. The system may provide the user with interface elements to adjust upper and lower bounds associated with friends' and family members' addresses.

In one or more embodiments, the system allows users to specify distances from addresses based on transportation types. For example, a user may specify a travel distance/time by car, walk, bike, bus, train, or airplane.

The system may determine a travel time from locations of interest to one or more target locations associated with selected attributes based on multiple types of transportation. For example, if a user selects an upper bound of “4 hours by plane” associated with a family member's address, the system may calculate the 4 hours based on flight data of airline schedules of airlines operating from a particular airport, travel time to and from the airport, parking time, and check-in time. In an embodiment, a system interfaces with an application programming interface (API) of a set of airlines to determine airline schedules for calculating travel time. Likewise, the system may interact with APIs of bus lines to determine bus schedules. The system may determine the availability of other commercial transportation, such as taxis, associated with locations of interest and/or addresses selected by a user, including addresses of friends and family.

While an embodiment is described above where a system identifies locations of interest based on identifying locations within overlapping geographic areas or zones, in another embodiment, the system identifies locations of interest based on identifying concentric geographic zones centered around a residence, neighborhood, or tract location. For example, instead of assigning a geographic boundary to a “hiking” location, such as a national park, and a geographic region to a “school” location (e.g., an elementary school) and identifying overlapping locations, the system may generate sets of geographic boundaries around a target location, such as a neighborhood, to determine whether specified attribute requirements are met based on the geographic boundaries.

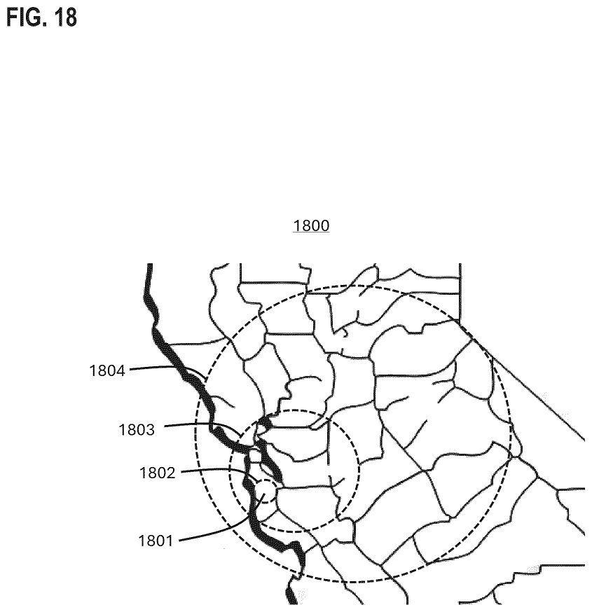

FIG. 18 illustrates an example of identifying a candidate location based on overlapping geographic areas or zones. As illustrated in FIG. 18, a system identifies a candidate location 1801. A first boundary 1802 corresponds to a first user-selected attribute and criteria, such as “walking distance to schools.” If the system determines one or more schools is located within the first boundary, the candidate location meets the first set of criteria for the first attribute. A second boundary 1803 corresponds to a second user-selected attribute, such as “driving distance to night life.” If the system determines a threshold number of bars, clubs, theaters, and/or restaurants is located within the second boundary 1803, the system determines the candidate location meets the second set of criteria for the second attribute. A third boundary 1804 corresponds to a third user-selected attribute, such as “driving distance to camping.” The system generates a larger radius for the third attribute based on the attribute type—i.e., camping versus of nightlife. If the system determines a threshold number of camping sites, state parks, and/or national parks is located within the third boundary 1804, the system determines the candidate location meets the third set of criteria for the third attribute. If the candidate location meets the first, second, and third sets of criteria for the first, second, and third attributes, the system presents the candidate location to the user in a GUI. While FIG. 18 illustrates a map 1800, the system may present the candidate location to the user in another form, such as in a list of candidate locations.

In an embodiment, users assign their wishes or preferences to geographic zones based on distance, drive time, biking time, walking time, or public transportation time. For example, a user may want crime to be low in their neighborhood but may be willing to drive 15 minutes for shopping, 30 minutes for dining, 60 minutes to an airport, and 3 hours to ski. A simple example follows:

| | | “Distance” | Unit of | |
|---|---|---|---|---|
| Zone | | from | “Distance” | |
| Number | Wish | Residence | measure | Travel Mode |
| (0) | Low crime | 0 | N/A | N/A |
| (1) | Park | <10 | minutes | walk |
| (2) | Costco | <20 | minutes | drive |
| (3) | Sex offenders | >20 | miles | N/A |
| (4) | Gas station | <5 | miles | N/A |
| (5) | Airport | <60 | minutes | public transit |
| (6) | National Park | <4 | hours | drive |
| (7) | Skiing | <4 | hours | drive |

In one or more embodiments, user-selected attributes may be “positive” attributes or “negative” attributes. Positive attributes include attributes a user desires to be near. Negative attributes are attributes a user does not desire to be near. An example of a positive attribute is “low crime.” Examples of negative attributes include “proximity to sex offenders,” “homeless areas,” or “tornado locations.” In the table, above, negative, and positive attributes are denoted by the “greater than” symbol “>” as contrasted with the “less than” symbol “<”. The “less than” symbol represents an inclusive zone (desire in that region), whereas the “greater than” symbol represents an exclusive zone (desire its absence in that region).

Zones also allow users to live near larger cities. The desire may not be binary (e.g., cities with populations over 1 million). They can choose whatever city criteria they like and even give multiple viable options with an “OR” function.

| | | “Distance” | Unit of | |
|---|---|---|---|---|
| Zone | | from | “Distance” | |
| Number | Wish | Residence | measure | Travel Mode |
| (1) | City of >1 million | <60 | minutes | public transit |
| OR (1) | City of >250K | <30 | minutes | drive |

IV. Allowing Users to Establish Limits on their Desired Attributes

The Wishlist attributes in block 301 may include a user-established upper bound, a user-established lower bound, and a user-established preference weight, in accordance with an implementation.

The Attributes by Location 302 is comprised of various locations, each containing the Wishlist attributes unique to each location, in accordance with an implementation.

FIG. 8A is an example depiction of a slider control method to set attribute values for Wishlist attributes, in accordance with an implementation. A GUI may display a pane 800 including an attribute. In the example illustrated in FIG. 8A, the attribute is “Annual Income.” The GUI presents a set of icons representing a value for the attribute. Icon 801 is a slider button representing a user selection of a lower bound. Icon 802 is a slider button representing a user selection of an upper bound. In the example illustrated in FIG. 8A, the lower bound icon 801 corresponds to an attribute value of $36 k. The upper bound icon 802 corresponds to an attribute value of $122 k. By moving the slider buttons 801 and 802, the user dynamically changes the desired upper and lower bounds of the Wishlist attributes 301.

The pane 800 further includes selectable icons 803, 804, and 805. Selectable icon 803 causes the GUI to present a “heatmap” representation associated with an attribute. For example, in the embodiment illustrated in FIG. 8A, where the attribute is “Annual Income,” the GUI may present a heatmap representation that shows (a) a first set of locations where the annual income falls within the user-selected bounds in a first shade of a color, (b) a second set of locations where the annual income falls outside the user-selected bounds, but is relatively close to the user-selected bounds in a second shade of the color, and (c) a third set of locations where the annual income falls outside the user-selected bounds by more than the second set of locations in a third shade of the color. While three shades of color are described here, embodiments encompass any number of shades of color representing varying levels of magnitude of an attribute.

The pane 800 further includes a selectable icon 804 to designate an attribute as a high priority attribute. Designating the attribute as a high priority increases a weight applied to the attribute by the Ranking Engine 303.

The pane 800 further includes a selectable icon 805 to generate a visualization based on the selected attribute, without including in the visualization other attributes in the user's Wishlist. For example, if a user's Wishlist includes attributes “Annual Income,” “Hiking,” and “Night Life,” the system may generate one visualization that includes locations associated with all three attributes. For example, the system may present in the GUI a neighborhood that includes high values for each of the attributes. If the user selects the “Just This” icon 805, the system may modify the visualization to remove “Hiking” and “Night Life” from the ranking. The system may display a set of cities that most closely match the user's selected salary range for the attribute “Annual Income.”

FIG. 8B is an example depiction of a toggle filter control display and method to set attribute values for Wishlist attributes, in accordance with an implementation. A system may display a pane 810 associated with the attribute “Hiking.” The pane 810 includes a set of toggle buttons 811. By selecting toggle buttons 811, the user dynamically establishes the desired upper and lower bounds of the Wishlist attributes 301. For example, selecting the toggle button 812 “some,” the system generates a set of predefined upper and lower bounds, such as “five or more hiking trails within 5 miles” and “hiking trails of at least one mile in length.” Selecting the toggle button 813 “epic” may generate different set of upper and lower bounds, such as “hiking trails of at least 15 miles in length within 20 miles” and “20 or more hiking trails within 30 miles.” A user may select both toggle button 812 and toggle button 813 to set “some” as the lower bound for the attribute “Hiking” and “epic” as the upper bound. Based on the user selecting the toggle buttons 812 and 813, the system may generate the lower bound for the attribute “Hiking” as “five or more hiking trails within 5 miles” and “hiking trails of at least one mile in length.” The system may set the upper bound as “hiking trails of at least 15 miles in length within 20 miles” and “20 or more hiking trails within 30 miles.”

The system may employ a toggle button filter to cause the selection of two toggle buttons to result in defining a lower toggle button as a lower bound and an upper toggle button as an upper bound. Accordingly, the toggle button filter allows for selection of only a contiguous set of attribute bounds values.

FIG. 8C is an example depiction of a ladder control display and method to set attribute values for Wishlist attributes, in accordance with an implementation. A GUI presents a pane 820 corresponding to an attribute “Major Airport.” The GUI presents a pane 830 corresponding to an attribute “Property Crime Rate.” The system is configured to permit a user to select a single toggle button. For example, the pane 820 includes toggle buttons 821a-821e. If the user had previously selected toggle button 821b, and the user currently selects toggle button 821c, the system de-selects toggle button 821b and selects toggle button 821c. The system determines whether to set the selected toggle button as an upper bound or a lower bound based on characteristics of the attribute. For example, the system may determine that a distance to an airport is a desirable attribute. Therefore, the system sets a value associated with toggle button 821c “2 hours” as an upper bound, indicating a user would desire to be 2 hours or closer to an airport rather than more than 2 hours from an airport.

The pane 830 includes toggle buttons 831 and 832. Based on a user selection of toggle button 832, the system generates an upper bound for the attribute “Property Crime Rate” of “Lowest half,” meaning the property crime rate of a location is in the lower half of property crime rates among all locations. By selecting toggle buttons, the user dynamically establishes a desired upper or lower bounds, but not both, of the Wishlist attributes 301.

### V. Comparing Attribute Values Against a Typical Norm

For several of the attributes, users will have some innate sense of what a desirable limit may be. For example, most people will be able to select the amount of snow they are willing to accept in an ideal living location. However, for many attributes, users have no such sense. For example, how much violent crime is acceptable, or how many hiking trails are desirable?

To address this understandable human limitation, some toggle filters (see FIG. 8B) present attribute controls in terms of what is typical or normal across all locations as compared to locations that possess less than normal, much less than normal, more than normal, or much more than normal levels of the selected attribute.

### VI. Allowing Users to Combine Attributes, Resulting in a Ranked List of Locations

Referring again to FIG. 3, Ranking Engine 303 implements an algorithm 305 that uses the information from Wishlist 301 and the Attributes by Location dataset 302 to compute a Match List 304, in accordance with an implementation. In an embodiment, the algorithm 305 is a rules-based algorithm. A rules-based algorithm includes a set of rules that specify how the system applies a user selection of a set of attributes, a user's rankings for the attributes, and any magnitude values applied to the attributes by the system to generate the match list 304.

In an alternative embodiment, the algorithm 305 includes a machine learning algorithm for training a machine learning model. The machine learning model receives sets of attribute data, ranking data, and location data as input values and generates a set of locations as output values. In an embodiment, generating the set of locations includes applying the machine learning model to each location in the set of locations to generate a matching score for each location, and ordering the locations according to their matching score.

For example, a system initially trains a neural network using a historical data set. Training the neural network includes generating n hidden layers for the neural network and the functions/weights applied to each hidden layer to compute the next hidden layer. The training may further include determining the functions/weights to be applied to the final, n-th hidden layer that compute the final label(s) or prediction(s) for a data point. Training the neural network includes: (a) obtaining a training data set, (b) iteratively applying the training data set to a neural network to generate labels for data points of the training data set, and (c) adjusting weights and offsets associated with the formulae that make up the neurons of the neural network based on a loss function that compares values associated with the generated labels to values associated with test labels. The neurons of the neural network include activation functions to specify bounds for a value output by the neurons. The activation functions may include differentiable nonlinear activation functions, such as rectified linear activation (ReLU) functions, logistic-type functions, or hyperbolic tangent-type functions. Each neuron receives the values of each neuron of the previous layer, applies a weight to each value of the previous layer, and applies one or more offsets to the combined values of the previous layer. The activation function constrains a range of possible output values from a neuron. A sigmoid-type activation function converts the neuron value to a value between 0 and 1. A ReLU-type activation function converts the neuron value to 0, if the neuron value is negative, and to the output value if the neuron value is positive. The ReLU-type activation function may also be scaled to output a value between 0 and 1. For example, after applying weights and an offset value to the values from the previous layer for one neuron, the system may scale the neuron value to a value between −1 and +1. The system may then apply the ReLU-type activation function to generate a neuron output value between 0 and 1. The system trains the neural network using the training data set, a test data set, and a verification data set until the labels generated by the trained neural network are within a specified level of accuracy, such as 98% accuracy. In one or more embodiments, the machine learning model is trained on a training dataset including user interest criteria and locations of interest to the user. The system may receive feedback based on predicted locations of interest to the user. The system may update the training dataset and retrain the model based on the feedback.

According to an embodiment, the system may apply the Ranking Engine 303 algorithm to the Wishlist 301 and Attributes by Location dataset 302 to compute a match percentage for each location in the Attributes by Location dataset 302. In one embodiment, the Attributes by Location dataset 302 specifies attributes for census tracts. For example, the Attributes by Location dataset 302 may include attributes of each census tract among the 84,414 census tracts that cover the United States. If the attribute value of a selected attribute for a location in the Attributes by Location dataset 302 is greater than or equal to the Wishlist attribute lower bound and less than or equal to the Wishlist attribute upper bound, the match percentage is 100%. Otherwise, the match percentage is proportional to the logarithm of the distance to the nearest bound.

### VII. Increased Weighting of User-Selected Critically Important Attributes

The Ranking Engine 303 algorithm may generate a weighted average Match List 304 by incorporating the user-established preference weight found in Wishlist 301, in accordance with an implementation.

Match List 304 may include each location, ranked and sorted per the algorithm of the Ranking Engine 303, in accordance with an implementation.

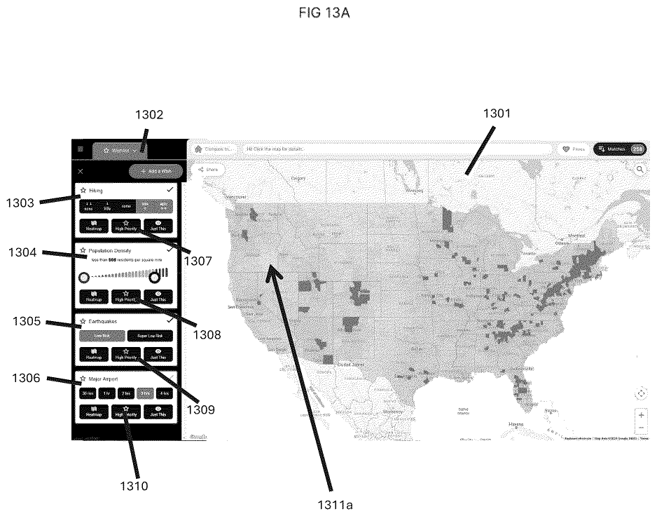

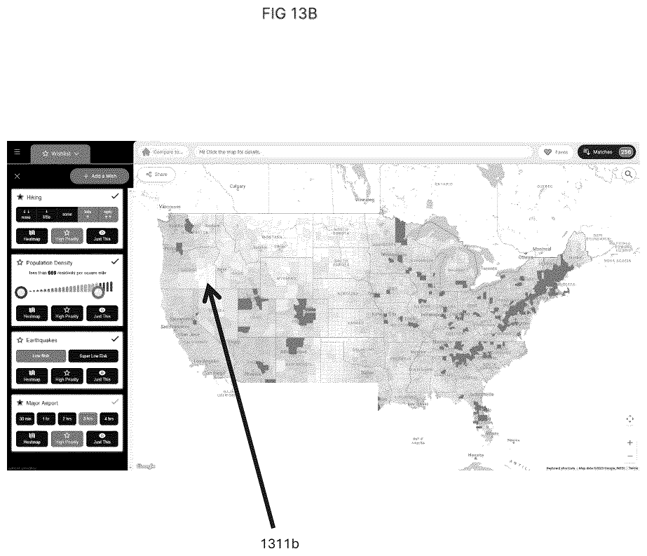

FIGS. 13A and 13B a display and method for modifying a user-selected weighting for selected attributes, in accordance with an implementation. A GUI displays a map 1301 and a panel 1302. The panel displays panes 1303, 1304, 1305, and 1306. The panes 1303-1306 correspond to respective attributes “Hiking,” “Population Density,” “Earthquakes,” and “Major Airport.” The panes include selectable icons 1307, 1308, 1309, and 1310. The selectable icons 1307-1310 correspond to a weighting function. When a user selects an icon 1307-1310, the system modifies attribute values for the corresponding attributes in the user's Wishlist to increase the weight applied to the corresponding attribute.

For example, absent a user input selecting a priority level or weight for a set of attributes, the system may apply an equal weight to each attribute. The Ranking Engine 303 applies the algorithm 305 to generate a match list 304 where each attribute is given equal weight. However, if a user selects the selectable icon 1307 to indicate “Hiking” is a high priority, the Ranking Engine 303 re-applies the algorithm 305 to the Wishlist 301 and the Attributes by Location dataset 302, where the attribute “Hiking” is assigned a greater weight by the algorithm 305. Accordingly, the Ranking Engine 303 generates a new Match List 304 in which locations with “Hiking” values that fall within user-selected bounds are displayed more prominently than other locations, including locations that have “Population Density” values and “Earthquake” frequency values that fall within user-selected bounds.

By selecting the “Must Have” button(s), the system dynamically changes the Match List 304. As illustrated in FIG. 13B, a user selects icons 1307 and 1310 to indicate the attributes “Hiking” and “Major Airport” are high priorities. The system modifies the map 1301 to change a set of highlighted areas based on the user selections to de-emphasize areas without hiking and proximity to a major airport. For example, county 1311a is presented in the GUI in FIG. 13A with a darker shading based on the priorities associated with the attributes in FIG. 13A. The neighborhood 1311b is presented with a lighter shading in the GUI in FIG. 13B based on the priorities selected in FIG. 13B.

Although implementations are depicted in the figures and described herein in the context of a user specifying an increased weighting by selecting the “High Priority” control on the graphical user interface, implementations are not limited to specifying a single weighting via a control option and may include options for selecting from multiple weightings. For example, according to an implementation, a slider control is provided that allows a user to specify a weighting along a scale between 0 and 100%, where 50% represents a normal weighting, 0% represents a minimal weighting, and 100% represents a maximum weighting. In addition, attributes of the slider control and scale, such as color, may change as the user moves the slider control to provide a visual indication of the corresponding weighting. For example, as the user moves the slider control towards 100%, the scale and indicated weighting change color to green and when the slider control reaches 100%, a “Must Have” icon is displayed. Similarly, as the user moves the slider control towards 0%, the scale and indicated weighting change color to yellow and when the slider control reaches 0%, a “Less Important” icon is displayed. According to an implementation, a sound is generated when the slider reaches 0% or 100% on the scale to audibly notify the user that an endpoint on the scale has been reached.

### VIII. Allowing Users to Use Desirable Reference Locations to Discover More Locations Sharing the Same Attributes

FIG. 4 is a flow diagram that depicts an approach for creating a sorted and ranked Correlation List 405, based on the user-established Reference Locations dataset 401, in accordance with an implementation.

The Reference Locations dataset 401 is comprised of various user-selected locations representing places the user likes and would like to find locations possessing similar location attributes, in accordance with an implementation.

The Attributes by Location dataset 402 is comprised of various locations, each containing the Wishlist attributes unique to each location, in accordance with an implementation. The Attributes by Location dataset 402 may correspond to the Attributes by Location dataset 302 illustrated in FIG. 3

The Attribute Definitions dataset 403 is comprised of a list of the locations from Reference Locations dataset 401, each location conveying its associated attributes and their values. From this list, for each attribute, the following values are computed: minimum attribute value, maximum attribute value, and attribute value correlation across locations, in accordance with an implementation.

Correlation List 405 may include each attribute, ranked and sorted per the algorithm 406 implemented by the Correlation Engine 404. The Correlation Engine 404 determines matches with high relevancy by considering locations that a user has expressed an interest in.

FIG. 7 is a flow diagram that depicts a workflow approach for Finding Matches by Example locations, in accordance with an implementation.

In block 702, user takes an action signifying interest in adding to their Wishlist by use of example locations.

In block 703, system displays a UI to search for locations.

In block 704, user enters a location search term, which prompts the system to display a list of locations matching the entered search term 705. The user may only select one location at a time, but may later select additional locations, again, one at a time. The system adds each of the selected locations to the Reference Locations List 707.

In block 708, system invokes the Correlation Engine (see FIG. 4) to generate or update the Correlation List 405.

In block 709, user selects and activates what they perceive to be important attributes from the Correlation List 405.

In block 710, system establishes upper and lower bounds for the activated attributes for all locations in the Reference Locations list 401.

In block 711, system invokes the Ranking Engine 303 to generate or update the Match List 304.

In block 712, user views results in map or list form 203

### IX. Ranking and Displaying Close Matches

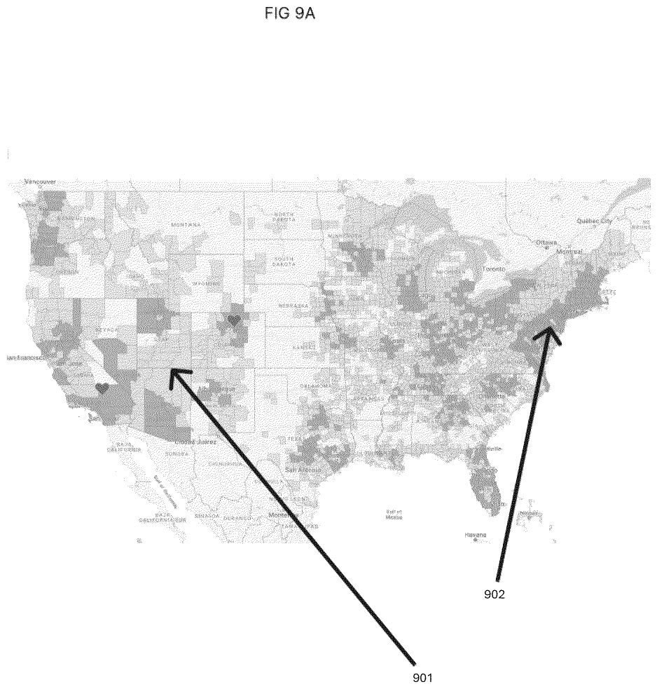

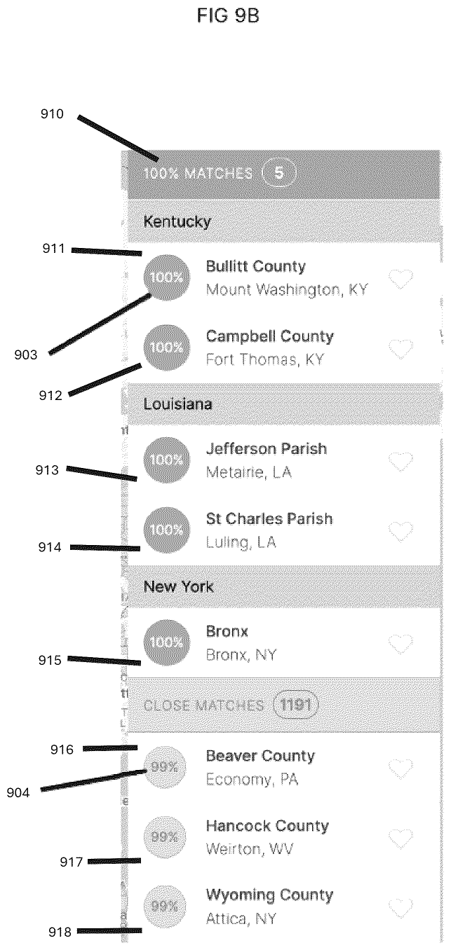

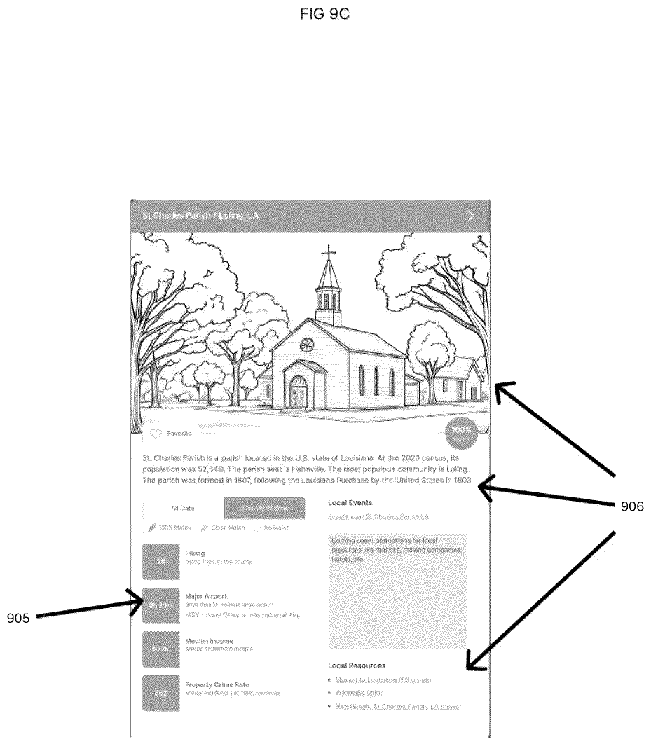

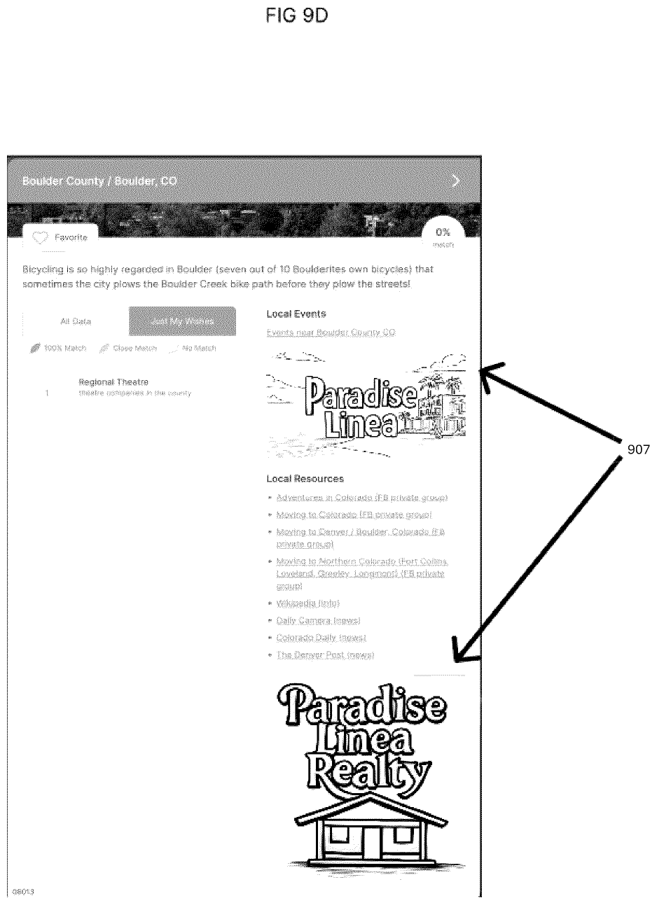

FIG. 9A is an example depiction of a map showing the difference between locations that are 100% (darker shading) on the match list 304, and those that are less than 100% (lighter shading), in accordance with an implementation. In one aspect, the shading corresponds to the level of location match quality. In one aspect, the “close matches” may have a system-established limit, below which the location will have no shading at all.

FIG. 9B is an example depiction of a list showing the difference between locations that are 100% (darker shading) on the match list 304, and those that are less than 100% (lighter shading), in accordance with an implementation. In one aspect, the shading corresponds to the level of location match quality. In one aspect, the “close matches” may have a system-established limit, below which the location will have no shading.

In the example illustrated in FIG. 9A, a region 902 includes locations with a dark shading, indicating close match. The close match may be determined by a Ranking Engine 303 based on user-selected attributes or by a Correlation Engine 404, based on locations determine to be of interest to a user. Region 901 includes locations displayed in a lighter shade, indicating a match less than 100% to the user-selected attributes or to attributes of a location of interest to a user.

In the example illustrated in FIG. 9B, a system displays a panel 910 in a GUI. The panel includes locations 911, 912, 913, 914, 915, 916, 917, and 918. The locations 911-918 may correspond to locations that most closely match a user's selected attributes or the attributes of a location of interest to the user. Icon 903 is displayed in one shade to represent a 100 percent match with a user's selected attributes. Icon 904 is displayed in another shade to represent a 99% match.

### X. Categorizing the Qualitative and Quantitative Measures as Descriptors for Locations

FIG. 9C is an example depiction of a Location Profile 207. The Location Profile includes both Quantitative Data 905 and Qualitative Data 906. Quantitative Data 905 may be comprised of the Attributes by Location 302. In one aspect, the qualitative data 906 may include images depicting the location. In one aspect, the qualitative data 906 may include hyperlinks to local news and information sources for each location. In one aspect, the qualitative data 906 may include notable facts about the location or notable people associated with the location. In one aspect, the qualitative data 906 may include information about or links related to events occurring in the location. In one aspect, the qualitative data 906 may include information about or links related to resources or services that may help the user further explore the location, such as social media groups with similar interests.

### XI. Monetizing Via Exploration Enhancing Advertisements

FIG. 9D is an example depiction of a Location Profile 207 containing both Quantitative Data 213 and Qualitative Data 214, in accordance with an implementation. In one aspect, the qualitative data may include informative advertisements 907 that support the user's ability to explore or relocate to the location, in accordance with an implementation. In one aspect, the advertisements 907 can represent location local realtors. In one aspect, the advertisements can represent location local hotels. In one aspect, the advertisements can represent location local destinations. In one aspect, the advertisements can represent location-supporting movers. In one aspect, the advertisements can represent location local restaurants. In one aspect, the advertisements can represent location-supporting mortgage brokers. In one aspect, the advertisements can represent location local rental managers. In one aspect, the advertisements can represent location-supporting travel agents or airlines. In one aspect, the advertisements can represent location local hiring employers.

### XII. Comparatively Displaying the Value Ranges for the Various Attributes Via Heatmaps

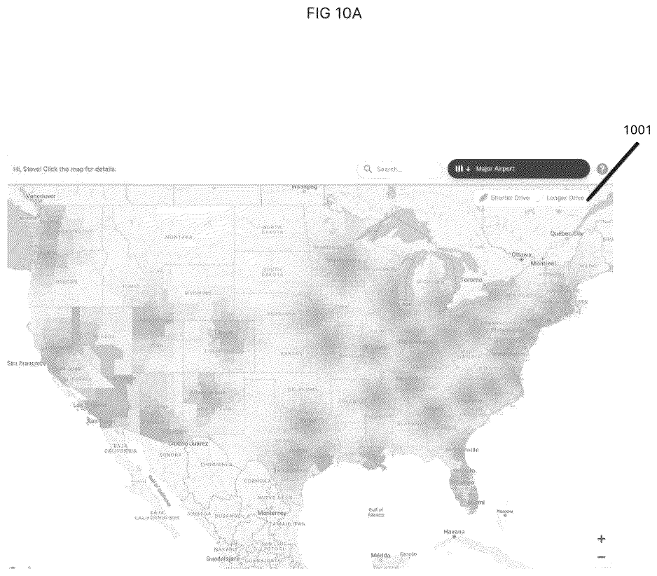

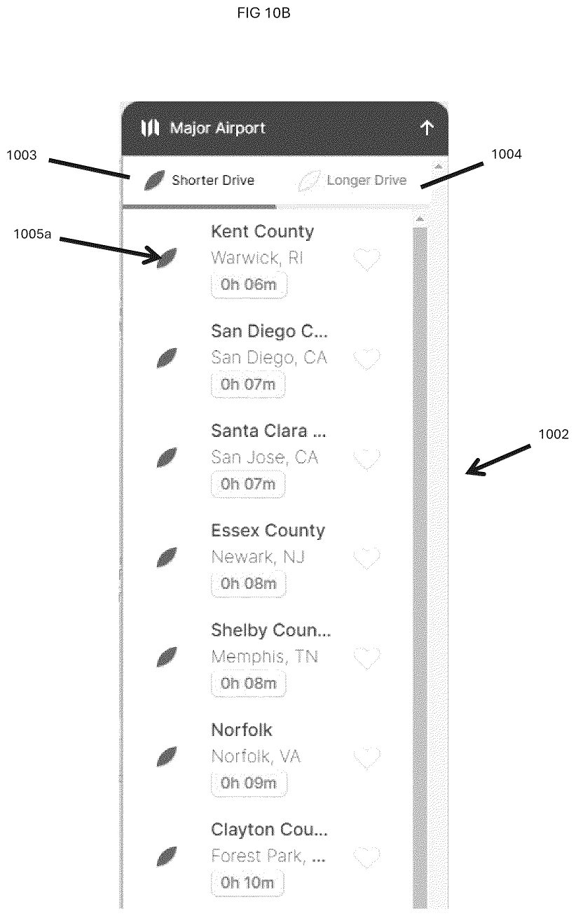

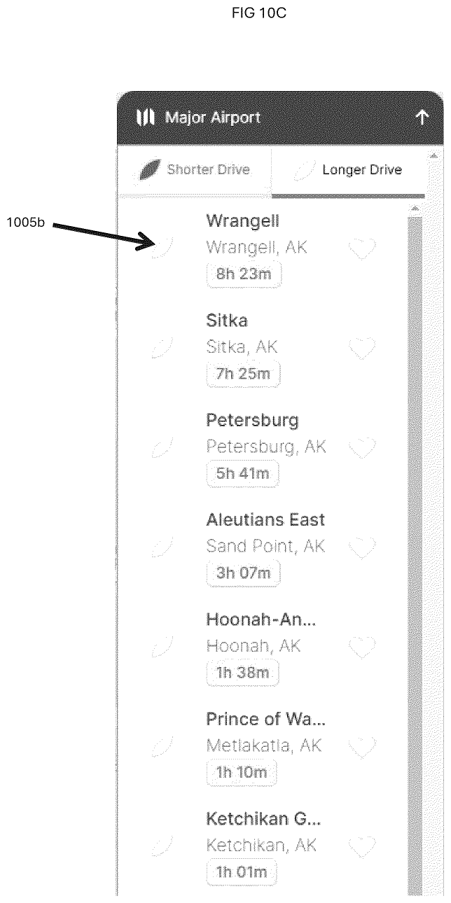

FIG. 10A is an example depiction of a map 1001 showing the variability of a select location attribute across all locations, in accordance with an implementation. In one aspect, the shading is monochromatic and shaded corresponding to the location quantitative data 213 for each location. In one aspect, the shading is polychromatic, the color transitions corresponding to the location quantitative data 213 for each location.

FIG. 10B is an example depiction of a list 1002 showing the variability of a select location attribute across all locations, in accordance with an implementation. In one aspect, the shading is monochromatic and shaded corresponding to the location quantitative data 213 for each location. In one aspect, the shading is polychromatic, the color transitions corresponding to the location quantitative data 213 for each location. In one aspect, the list may be ordered by the value of the location attribute. In one aspect, the list may be reverse ordered by the value of the location attribute. As illustrated in FIG. 10B, the GUI displays a “Shorter Drive” tab 1003. When selected, the system modifies the display to arrange the locations 1002 in order from shortest drive (top) to longest drive (bottom). The GUI displays a “Longer Drive” tab 1004. When selected, the system modifies the display to arrange the locations 1002 in order from longest drive (top) to shortest drive (bottom).

The GUI presents an icon 1005a that is shaded to represent a magnitude associated with the attribute. In FIG. 10B, the icon 1005a is shaded with a dark shading to represent a short drive (“6 minutes”) to a major airport. Referring to FIG. 10C, the icon 1005b is shaded with a light shading to represent a longer drive (“8 hours and 23 minutes”) to a major airport.

### XIII. Allowing Users to Select Favorites

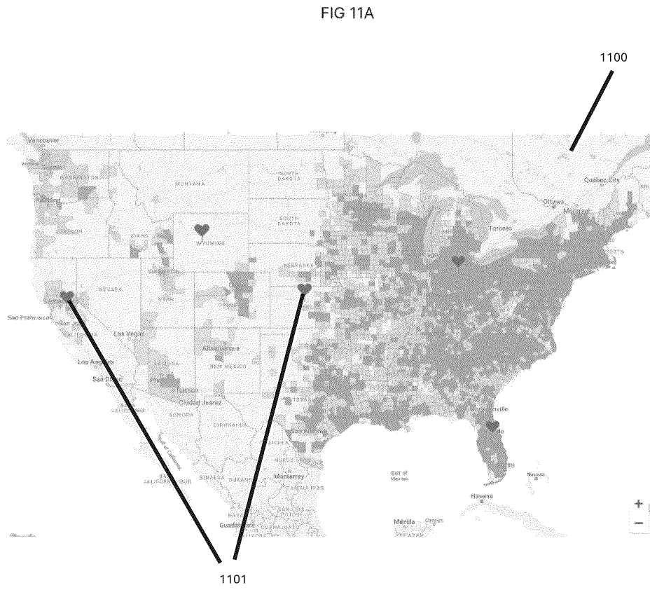

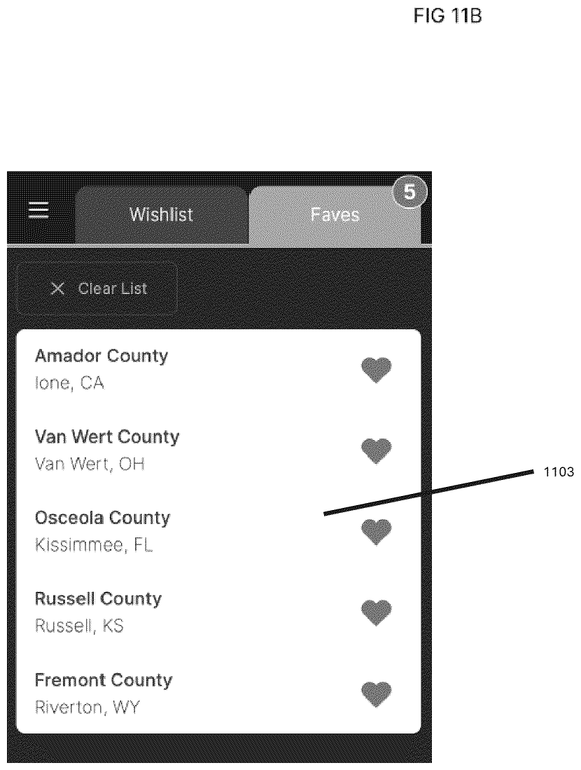

FIG. 11A is an example depiction of a map 1100 showing the user-selected favorite locations 1101 against the backdrop of all locations, in accordance with an implementation. In one aspect, the favorite locations are identified by a superimposed icon on the map. In one aspect, the favorite locations are identified by a bold or colored outline for the select locations. In one aspect, the favorite locations are identified by a differentiated color for the select locations. In one aspect, the location may be selected or deselected as a favorite on the match list (see FIG. 9B—click heart icon) or the location profile (see FIG. 9C—click “Favorite” button).

FIG. 11B is an example depiction of a list 1103 showing the user-selected favorite locations, in accordance with an implementation. In one aspect, the location may be deselected as a favorite on the favorite list.

### XIV. Isolating Attributes to Allow Dynamic Selection of Limits

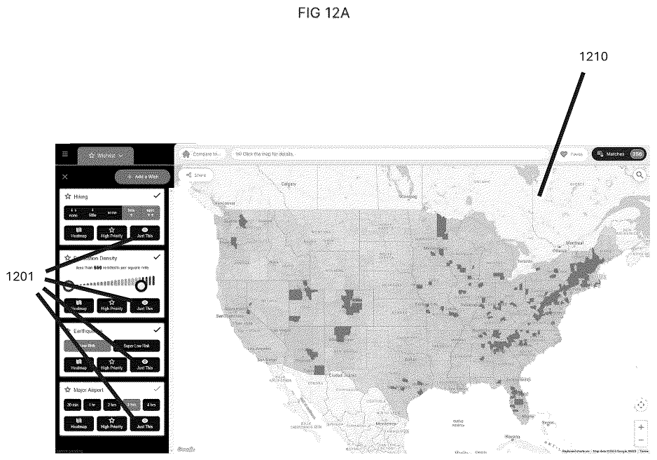

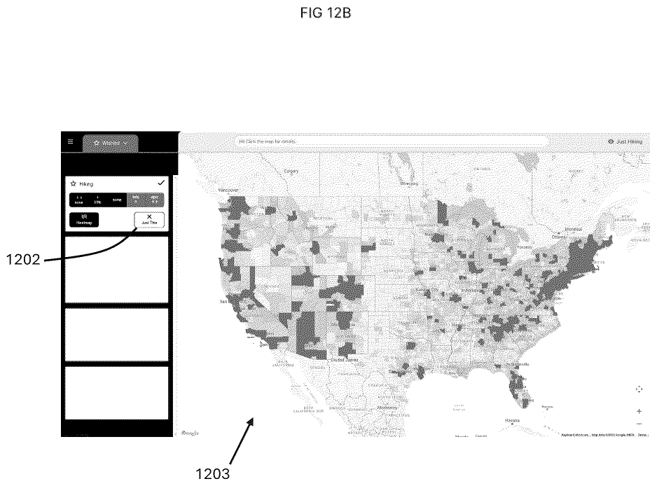

FIG. 12A is an example depiction of a map 1210 showing how a select Wishlist attribute can be isolated, temporarily ignoring all other Wishlist attributes, in accordance with an implementation. As the user activates more and more attributes onto the Wishlist 301, it gets more difficult to distinguish the impact of any single attribute and its limits on the match list 304. To remedy this problem, the user can toggle the “Just This” button 1201.

FIG. 12B is an example depiction of a map demonstrating what would happen when the “Just This” 1202 button for the attribute “Hiking” is activated. In one aspect, when the “Just This” button 1202 for the attribute “Hiking” is activated, the other activated attributes are temporarily deactivated. In one aspect, when the “Just This” button for the attribute “Hiking” is activated, the other activated attribute are temporarily grayed out or hidden from the user. In one aspect, when the “Just This” button for the attribute “Hiking” is activated, the map 1210 is temporarily recolored as if only the “Just This” attribute was activated. In one aspect, when the “Just This” button is activated, the attribute controls allow the user to observe the impact of changing the attribute settings as if only the “Just This” selected attribute is active, as indicated by the reference numeral 1203 in FIG. 12B.

XV. Allowing Users to Create Profiles, Including their Ranked Location Lists and Favorites

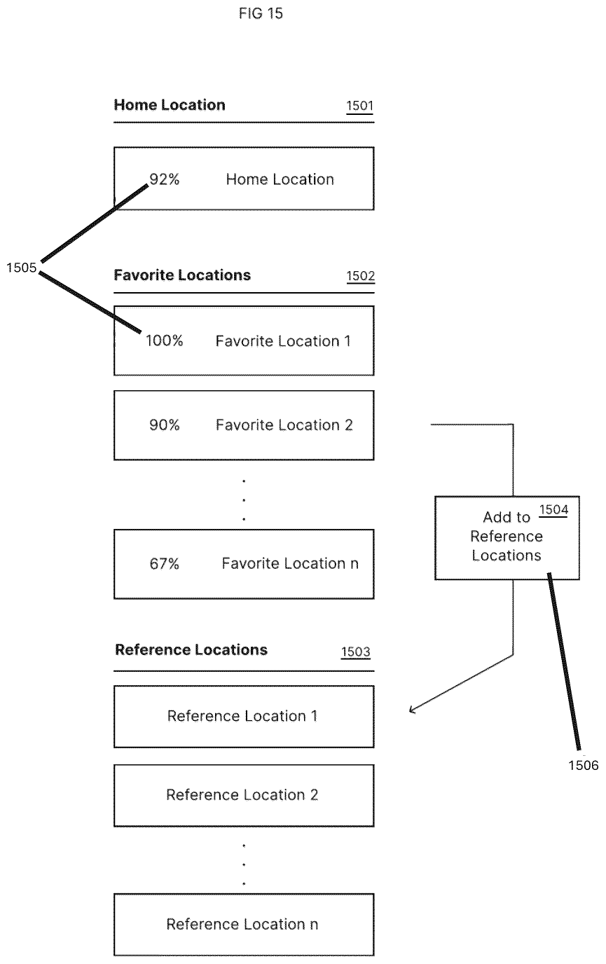

FIG. 15 is an example of a UI presenting three different location categories related to the user, in accordance with an embodiment of this invention. The first category is Home Location 1501, which represents the user's current living location or primary residence. The second category is Favorite Locations 1502, which represents the locations the user is interested in exploring as a possible future move location. The third category is Reference Locations 1503, which represents locations the user likes and would like to find locations with similar attributes for a possible future move location. In one aspect, the locations are listed with their match list 304 percentage score 1505. In one aspect, the locations are listed with their match rank, relative to all the locations. In one aspect, locations in one category may be automatically also included in a different category 1504. In one aspect, locations in one category may also be manually included in a different category.

XVI. Allow Users to “Score” and Rank their Current Living Location for Use as a Reference

The user's home or current living location may be distinctly visible in the UI as an indicator of how satisfied they are living there, in accordance with an embodiment of this invention. In one aspect, the home location will be accompanied by the location's match list 304 percentage score to show the user how well their home location satisfies their ideal. In one aspect, the home location will be accompanied by the location's match rank relative to all the locations. The match rank will indicate to the user the number of other locations that are perhaps more ideal than their current home location.

XVII. Allowing Users to Share their Profiles 14A/14B/14C

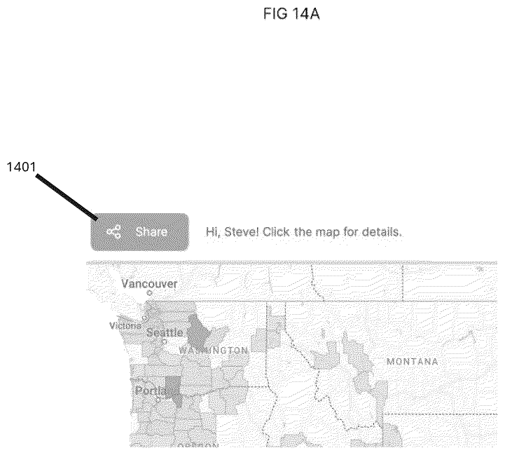

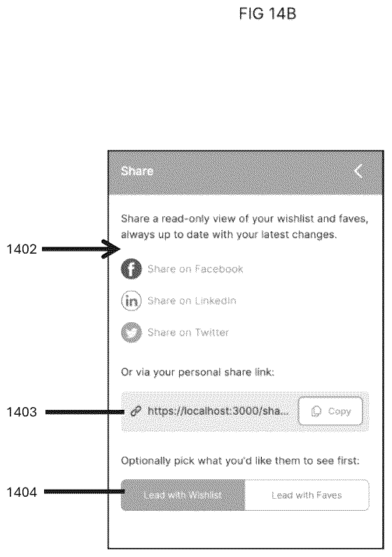

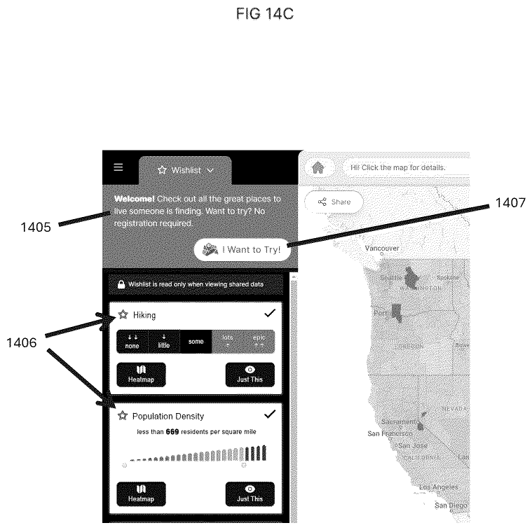

FIG. 14A is an example depiction of a button feature 1401 in a GUI allowing the user to share their experience and data, in accordance with an implementation. When considering something as meaningful as a move, it is often prudent to seek the counsel of trusted friends or family.

FIG. 14B is an example depiction of sharing options available to a user, in accordance with an implementation. In one aspect, the options would include the ability to share on multiple social media platforms 1402. In one aspect, the options would include the ability to share via email 1403. In one aspect, the options would include the ability to select the information a user may choose to share 1404. In one aspect, one of the elements of sharable information would be the Wishlist 301 and corresponding match list 304. In one aspect, one of the sharable elements would be the favorites list (see FIGS. 11A and 11B).

FIG. 14C is an example depiction of a sharee experience after accepting the invitation to explore from the original sharing user, in accordance with an implementation. In one aspect the sharee is presented the sharing user's experience, but with all UI controls locked so they cannot edit the sharing user's experience. That is, the sharee will be presented with a read-only experience. In one aspect, the sharee is offered the opportunity to try the website themselves in a full read/write manner without altering the sharing user's account. In one aspect, the sharing user may establish several different profiles under a single account so they can share different results with different sharees.

As illustrated in FIG. 14C, the invitation to share in a user's experience by viewing attributes and candidate locations includes a welcome message 1405 and a selectable button 1407. Selection of the selectable button 1407 may cause the system to generate a new profile for the new user. The system may allow the new user to view a user's selected attributes without modifying the attributes. However, the GUI may present selectable radio buttons 1406 to allow the new user to indicate approval/importance of a user's selected attributes. Selection of the radio buttons 1406 may provide feedback to the user, such as with a notification “Guest thinks “Hiking” is important!”

### XVIII. Scoring Locations by Subjective “Feel” Attributes

One or more embodiments apply a generative artificial intelligence (AI) model to location data to generate subjective scores for locations.

A system obtains a user input specifying a subjective descriptor. For example, a user may generate an input to request recommendations for the most boring, exciting, family-friendly, singles-friendly, senior-friendly, or neighborly city. Alternatively, a user may request a recommendation for cities with the strongest “hippie vibe” or the most laid-back cities. The user input may specify a subjective attribute, or an attribute that cannot be directly measured. Based on the user input, the system generates a prompt, or set of prompts, for a generative AI model to generate scores for a set of locations, such as a set of cities/towns, counties, census tracts, neighborhoods, or zip codes. For example, the system may generate a prompt for the generative AI model to generate scores for each city and town in the United States. Based on the scores, the system presents to the user a set of one or more locations that match the user's request for a recommendation.

For example, a user may enter text into a search field to query which cities have the strongest “hippie vibe.” The system may generate a first prompt to a generative AI model requesting that the generative AI model identify a city that has the strongest hippie vibe. The generative AI model may return “San Francisco.” The system may generate an additional prompt that specifies (a) the “hippie vibe” attribute and (b) a list of cities. The prompt may further include instructions to assign a numerical value, on a scale of 0 to 100, to represent a scoring of the city corresponding to the attribute, where San Francisco corresponds to a score of 100. The generative AI model may generate the following list:
Boulder, CO: 85
New Orleans, LA: 65
Boston, MA: 40
Miami, FL: 35
Salt Lake City, UT: 30
Phoenix, AZ: 25
Des Moines, IA: 20

As another example, a user may request a list of the most exciting cities. The system may generate a set of prompts to the generative AI model that results in the following list:
New York City, NY: 100
San Francisco, CA: 90
Miami, FL: 88
New Orleans, LA: 85
Boston, MA: 80
Boulder, CO: 65
Phoenix, AZ: 60
Salt Lake City, UT: 50
Des Moines, IA: 35
Lubbock, TX: 0

In addition to applying a generative AI model to identify a subjective feel of locations, one or more embodiments apply a generative AI model to provide users with a description of location personalities.

A system may categorize sets of personality-like qualities that may be applied to locations of interest. Examples of categorized sets of personality-like qualities are included below.

### ###Atmosphere and Energy

Electric with opportunity
Laid-back beachy vibe
Fast-paced and driven
Vibrant and bustling
Quietly refined
Nostalgically charming
Gritty and resilient
Warm and welcoming
Sophisticated and cultured
Bold and ambitious
Playful and quirky
Serious and goal-oriented
Dynamic and constantly changing
Traditional but evolving
Calm and predictable

### ###Cultural Feel

Deeply historic
Cutting-edge modern
Eclectic and diverse
Blue-collar hardworking
Academic and intellectual
Artsy and avant-garde
Traditional and rooted
Funky and unconventional
Patriotic and proud
Urbane and polished
A place of reinvention
Strong local heritage
Global and worldly
Rooted in Americana
Spiritually enriching

### ###Lifestyle Perceptions

Family-focused
Young and energetic
Retiree-friendly
Health-conscious
Entrepreneurial
Relaxed and carefree
Community-centered
Outdoorsy and adventurous
Stylish and trendy
Close-knit and supportive
Independent and self-sufficient
Health-forward and active
Centered on work-life balance
Socially conscious
Technologically forward

### ###Environmental and Natural Qualities

Coastal and breezy
Mountainous and rugged
Green and leafy
Desert-like and serene
Open and expansive
Woodsy and tranquil
Urban and dense
Waterfront and scenic
Snowy and picturesque
Sunny and cheerful
Foggy and mysterious
Dramatic landscapes
Flat and wide-open
Urban-industrial
Serene waterfronts

### ###Social and Emotional Energy

Friendly and approachable
Reserved but polite
Proudly independent
Close-knit and tight-lipped
Hardworking and industrious
Creative and inspired
Traditional and conservative
Progressive and innovative
Relaxed and unhurried
Ambitious and upwardly mobile
Prideful and confident
Warm but reserved
Edgy and provocative
Steadfast and reliable
Youthful yet grounded

### ###Regional and Cultural Influences

Southern charm
Midwestern warmth
Northeastern sophistication
Western frontier spirit
Pacific Coast cool
Heartland simplicity
Urban grit
Suburban ease
Small-town familiarity
Big-city grandeur
Farm-to-table focused
Strong Indigenous influence
Military-connected pride
Religious or spiritual roots
Entrepreneurial frontier spirit

### ###Recreational and Leisure Vibes

Outdoorsy and adventurous
Thriving nightlife
Arts and theater haven
Sports-obsessed
Music scene hotspot
Foodie paradise
Shopping-centric
Coffee culture hub
Family-friendly fun
Peaceful and meditative
Thrill-seeker's paradise
A retreat for relaxation
Festival-friendly and celebratory
A haven for book lovers
A creative workshop hub
Outdoor gathering-friendly (parks, picnics)
A place to “unplug” and disconnect
Family holiday destination
A mecca for sports fans
Rich with seasonal traditions (e.g., fall festivals, holiday markets)

A system generates a generative AI prompt that includes a personality-like quality and a set of locations. In an example embodiment, the set of locations corresponds to a set of census tracts. A generative AI model scores each location in the set of locations on its applicability to the personality-like quality. In one embodiment, the system applies the generative AI model to (a) tens of personality descriptors, and (b) tens of thousands of locations, such as census tracts. For example, the system may apply the generative AI model to generate personality scores for 50 different personality descriptors and 84,414 census tracts in the United States.

The system may store a set of personality attribute values for each location, such as each census tract. When the system generates a location of interest for a user based on a user's selection of attributes, the system may present to the user a natural language description of the “personality” of the location of interest based on the personality descriptor rankings generated by the generative AI model.

As an example, the system may identify the Willow Glen neighborhood in Santa Clara, California as a location of interest based on user-selected attributes. The Willow Glen neighborhood corresponds to Census Tract 5024. The system stores and presents the following information about Census Tract 5024:

“Census Tract 5024 in Santa Clara County, California, encompasses a diverse community within the San Jose area. While specific social and emotional energy qualities can be subjective and vary among residents, here's a general assessment relative to the broader United States:
Friendly and approachable: 75
   The community is welcoming, reflecting the general openness found in many Californian neighborhoods.
Reserved but polite: 65
   While friendly, there's a degree of reservation typical in suburban settings.
Proudly independent: 70
   Residents value their community's unique identity within the larger urban area.
Close-knit and tight-lipped: 60
   There's a sense of community, though not as insular as in some rural areas.
Hardworking and industrious: 80
   Reflecting Silicon Valley's ethos, the area is home to many professionals and entrepreneurs.
Creative and inspired: 70
   Proximity to tech hubs fosters a creative and innovative spirit.
Traditional and conservative: 55
   The community leans more progressive, aligning with broader Californian trends.
Progressive and innovative: 75
   Influenced by nearby tech industries, there's an embrace of new ideas and technologies.
Relaxed and unhurried: 70
   While industrious, residents maintain a balanced, laid-back lifestyle.
Ambitious and upwardly mobile: 80
   The area's proximity to Silicon Valley attracts ambitious individuals seeking growth.
Prideful and confident: 75
   Residents take pride in their community and its achievements.
Warm but reserved: 65
   There's a balance of warmth and privacy among residents.
Edgy and provocative: 45
   The community is more conventional, with less emphasis on avant-garde lifestyles.
Steadfast and reliable: 80
   A stable community with long-term residents contributing to its reliability.
Youthful yet grounded: 70
   A mix of young professionals and established families provides a dynamic yet stable environment.”

In one embodiment, the system presents neighborhood personality scores as numerical values. Additionally, or alternatively, the system may present neighborhood personality scores in comparison to other scores or to an average value, such as a city, county, state, or national average. In an embodiment, the system applies the generative AI model to the personality score data to generate a natural language description of a neighborhood.

IXX. Presenting Social Media Content Associated with Locations of Interest

As users peruse locations of interest, they may be interested to see activities and sights in the vicinity of particular locations. One or more embodiments curate digital image content to present in a GUI based on image content and distance from a location-of-interest. A system determines a location-of-interest to a user based on a set of attributes selected by a user. The system scrapes websites, such as social media platform websites, to identify a set of candidate digital images. The system determines location data associated with the candidate digital images and activity content associated with the candidate digital images. If the digital images meet content criteria and correspond to locations less than a threshold distance from a location-of-interest, the system presents the digital image content in a GUI.

For example, a user may select a set of attributes including “hiking,” “close to elementary school,” and “low crime” in a user interface. Based on the user selections, the system identifies three neighborhoods that meet the selected criteria. The system scrapes social media websites to identify images with location data that is within a defined distance of any of the three neighborhoods. The system further analyzes one or both of image content and caption content to determine the subject matter of the images. The system presents a set of hiking-related images to a user, together with a location-of-interest identifier, based on determining the hiking-related images were taken within 15 miles of the location-of-interest. Similarly, the system may present an image of an elementary school taken within 5 miles of the location of interest.

One or more embodiments present social media image content associated with locations of interest based on a user's selected attributes in a GUI.

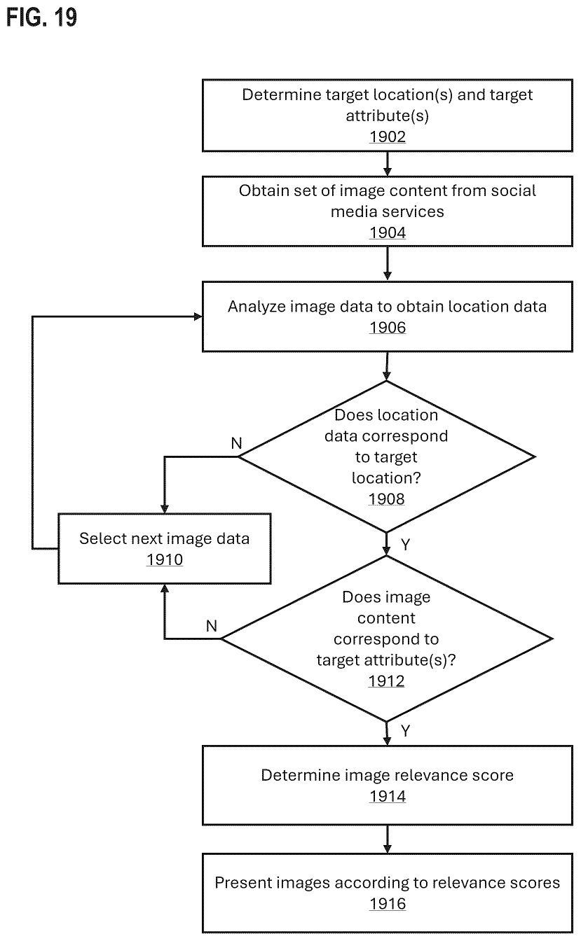

Referring to FIG. 19, a system determines a target location and target attributes (Operation 1902). The target location may be a location of interest determined by a system based on a set of attributes selected by a user.

The system obtains a set of image content from social media services (Operation 1904). For example, the system may interface with an API of a social media platform to identify content that the platform provides free of charge to the public. Examples of social media platforms include FACEBOOK, INSTAGRAM, PINTEREST, TIKTOK, X, GOOGLE MAPS, and YOUTUBE. Examples of image content include video content and still image content.

In an embodiment, the system accesses image content based on a date associated with the image content. Users may be far more interested in hiking videos from last week than they are about videos from 5 years ago. A system may execute one or more date-based content searches to identify image content. As an example, a first search may be for image content generated within the last year. Based on an amount of content returned, the system may execute an additional search for content within the past three months, one month, or two weeks. In an embodiment, the date range may be based on a location associated with an attribute. For example, a remote location may be associated with less image content than an urban location. Accordingly, the system may apply a date-based filter with a longer date range, such as a month, to image content associated with a remote location. The system may apply a date-based filter with a shorter date range, such as a week, to image content associated with an urban location.

While filtering image content based on a date associated with the image content is described in connection with Operation 1904, in some embodiments the date-based filtering may be performed in connection with Operation 1914, described below, after the system has identified locations associated with image content. In some embodiments, the system repeats the date-based image content filtering on a regular basis, such as weekly or monthly.

The system analyzes the image content to obtain location data (Operation 1906). The system may obtain the location data from metadata stored in the image, such as Exchangeable Image File Format (EXIF) data. Additionally, or alternatively, the system may determine an image location from context data, such as a caption or a social media post that includes the name of the location. Additionally, or alternatively, the system may perform a reverse image lookup of the image to determine the location of the image. A reverse image lookup service may receive an image and provide a location for the image based on visual content in the image.

In an embodiment, the system establishes geographic coordinates (e.g., latitude and longitude) of the image content.

The system determines if the location data of the image corresponds to a target location (Operation 1908). The target location may be, for example, a location identified by the system as a location of interest to a user based on attributes selected by the user. In one or more embodiments, the system determines the distance from the location associated with the social media image content and the target location.

In one or more embodiments, the system determines whether a location of image content is within a threshold distance of a target location. In addition, different attributes may be associated with different distance thresholds. For example, a threshold distance associated with an outdoor recreation attribute, such as hiking, boating, or biking, may be different than a threshold distances associated with other attributes, such as dining, amusement park, or beach. For example, the system may set a threshold distance of 10 miles for a user-selected attribute “dining.” The system may set a 25 mile threshold distance for a user-selected attribute “performing arts.” Accordingly, the location data for video content about a restaurant may be determined to be relevant to a user's location of interest if it is geolocated within 10 miles of the user's location of interest. A video about a skiing adventure may be determined to be relevant to a user's location of interest if it is geolocated within 200 miles of the user's location of interest.

If the location information associated with the location data does not correspond to the target location, the system selects another set of image data (Operation 1910).

If the location information corresponds to a target location, the system determines if image content corresponds to one or more target attributes (Operation 1912). In particular, the system determines if attributes associated with the image correspond to attributes selected by a user. In one embodiment, the system analyzes context associated with the image to determine if the image content corresponds to target attributes. Image content may include, for example, caption content, article content, and social media post content. Additionally, or alternatively, the system may apply an image recognition type application or model to identify image content based on visual representations within the image.

One or more embodiments determine if image attributes correspond to target attributes by applying a “gray list” to user-selected attribute terms. The gray list may specify terms that are similar to user-selected attributes. For example, if a user selects an attribute “hiking” the system may search for the term “hiking,” as well as the terms “trekking” and “backpacking” in image description content. The system may identify a first set of candidate social media posts including image content based on a search performed using the gray list. Based on receiving the first set of candidate social media posts, the system may further apply a “whitelist” to the first set of candidate social media posts to search for terms within the posts that are related to user-selected attribute terms. For example, the terms backcountry, climber, footpath, trailhead, and walking stick may be whitelist terms that the system searches for in image description content to identify images related to the “hiking” attribute. Applying the whitelist to the social media posts further filters the set of candidate social media posts to generate a second set of social media posts.

If the image content corresponds to one or more target attributes, the system determines an image relevance score (Operation 1914). In some embodiments, determining the image relevance score includes determining a number of relevant terms associated with an attribute. For example, a social media post that briefly describes hiking nearby may be assigned a lower score than a social media post describing a user's experience on a hike. Similarly, a social media post describing the location of a restaurant may be assigned a lower relevance score than a restaurant review.

In one or more embodiments, determining an image relevance score includes determining characteristics of an author of a social media post. For example, a prominent social media influencer may be assigned a higher relevance score than an anonymous poster.

In one or more embodiments, determining the image relevance score includes comparing terms in a social media post with a set of filter terms (blacklist) to filter out social media posts with a particular type of content, such as vulgarity, paid promotions, sales-oriented, or contentious. In one embodiment, users may select filters to apply to content to determine the relevance score. An example rubric for filters to apply to image content to determine the relevance score is provided below.

Evaluate each of the social media posts and filter out all those that fail to match the following:

Video duration must be between two limits, one short (e.g., 15 seconds) and the other long (e.g., 10 minutes).

Distance from the video recording location to the location of interest must be within the maximum allowable distance for the given topic. We don't want videos of a Yosemite waterfall hike if we want to explore Atlanta, Georgia.

The post caption must not contain any of the blacklisted terms.

The post caption must contain at least one of the whitelist terms.

The influencer username must not be vulgar or offensive.

The posting date must be nearer than an assigned cutoff date to ensure the content is fresh.

The language of the post caption must be in keeping with the desired local language (i.e., English in the United States)

If the post satisfies the filters above, a system may apply a generative AI model to the image content to determine a relationship of the image content to a set of query terms, such as user-selected attributes, synonyms, and related terms. For example, the system may analyze text content in a social media post that includes a video to determine the relationship of the image content to the query terms. Additionally, or alternatively, if the system determines a social media post is associated with multiple topics, to save on computing resources, the system may apply the generative AI model to determine whether any of the multiple topics corresponds to a target attribute.

The system presents one or more images to a user in a GUI based on the image relevance score (Operation 1916). For example, the system may present a set of videos and/or images on a webpage. The system may generate a set of locations of interest to a user in one panel of a GUI based on user selections. The system may generate previews of social media content, links to videos, and/or embedded videos or images that relate to the users' locations of interest in another panel of the GUI.

### XVIII. Implementation Mechanisms, Alternatives & Extensions

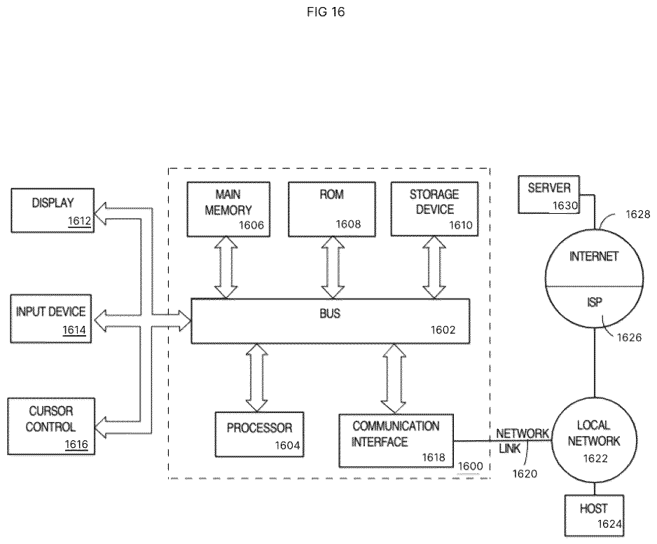

The approach described herein for helping users interactively discover and explore ideal personalized living locations is applicable to a variety of contexts and implementations and is not limited to a particular context or implementation. FIG. 16 is a block diagram that illustrates a computer system 1600 upon which an implementation may be implemented. Computer system 1600 includes a bus 1602 or other communication mechanism for communicating information, and a processor 1604 coupled with bus 1602 for processing information. Computer system 1600 also includes a main memory 1606, such as a random access memory (RAM) or other dynamic storage device, coupled to bus 1602 for 1storing information and instructions to be executed by processor 1604. Main memory 1606 also may be used for storing temporary variables or other intermediate information during execution of instructions to be executed by processor 1604. Computer system 1600 further includes a read only memory (ROM) 1608 or other static storage device coupled to bus 1602 for storing static information and instructions for processor 1604. A storage device 1610, such as a magnetic disk or optical disk, is provided and coupled to bus 1602 for storing information and instructions.

Computer system 1600 may be coupled via bus 1602 to a display 1612, such as a cathode ray tube (CRT), for displaying information to a computer user. An input device 1614, including alphanumeric and other keys, is coupled to bus 1602 for communicating information and command selections to processor 1604. Another type of user input device is cursor control 1616, such as a mouse, a trackball, or cursor direction keys for communicating direction information and command selections to processor 1604 and for controlling cursor movement on display 1612. This input device typically has two degrees of freedom in two axes, a first axis (e.g., x) and a second axis (e.g., y), that allows the device to specify positions in a plane.

The invention is related to the use of computer system 1600 for implementing the techniques described herein. According to one implementation, those techniques are performed by computer system 1600 in response to processor 1604 executing one or more sequences of one or more instructions contained in main memory 1606. Such instructions may be read into main memory 1606 from another machine-readable medium, such as storage device 1610. Execution of the sequences of instructions contained in main memory 1606 causes processor 1604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 1600, various machine-readable media are involved, for example, in providing instructions to processor 1604 for execution. Such a medium may take many forms, including but not limited to, non-volatile media, volatile media, and transmission media. Non-volatile media includes, for example, optical or magnetic disks, such as storage device 1610. Volatile media includes dynamic memory, such as main memory 1606. Transmission media includes coaxial cables, copper wire and fiber optics, including the wires that comprise bus 1602. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 1604 for execution. For example, the instructions may initially be carried on a magnetic disk of a remote computer. The remote computer can load the instructions into its dynamic memory and send the instructions over a telephone line using a modem. A modem local to computer system 1600 can receive the data on the telephone line and use an infra-red transmitter to convert the data to an infra-red signal. An infra-red detector can receive the data carried in the infra-red signal and appropriate circuitry can place the data on bus 1602. Bus 1602 carries the data to main memory 1606, from which processor 1604 retrieves and executes the instructions. The instructions received by main memory 1606 may optionally be stored on storage device 1610 either before or after execution by processor 1604.

Computer system 1600 also includes a communication interface 1618 coupled to bus 1602. Communication interface 1618 provides a two-way data communication coupling to a network link 1620 that is connected to a local network 1622. For example, communication interface 1618 may be an integrated services digital network (ISDN) card or a modem to provide a data communication connection to a corresponding type of telephone line. As another example, communication interface 1618 may be a local area network (LAN) card to provide a data communication connection to a compatible LAN. Wireless links may also be implemented. In any such implementation, communication interface 1618 sends and receives electrical, electromagnetic, or optical signals that carry digital data streams representing various types of information.

Network link 1620 typically provides data communication through one or more networks to other data devices. For example, network link 1620 may provide a connection through local network 1622 to a host computer 1624 or to data equipment operated by an Internet Service Provider (ISP) 1626. ISP 1626 in turn provides data communication services through the world wide packet data communication network now commonly referred to as the “Internet” 1628. Local network 1622 and Internet 1628 both use electrical, electromagnetic, or optical signals that carry digital data streams. The signals through the various networks and the signals on network link 1620 and through communication interface 1618, which carry the digital data to and from computer system 1600, are exemplary forms of carrier waves transporting the information.

Computer system 1600 can send messages and receive data, including program code, through the network(s), network link 1620 and communication interface 1618. In the Internet example, a server 1630 might transmit a requested code for an application program through Internet 1628, ISP 1626, local network 1622 and communication interface 1618.

The received code may be executed by processor 1604 as it is received, and/or stored in storage device 1610, or other non-volatile storage for later execution. In this manner, computer system 1600 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage, or attribute that is not expressly recited in a claim should limit the scope of such claim in any way. The specification and drawings are, accordingly, to be regarded in an illustrative rather than a restrictive sense.

1. (canceled)

2. (canceled)

3. (canceled)

4. One or more non-transitory computer-readable media comprising instructions which, when executed by one or more hardware processors, cause performance of operations comprising:
detecting a first user input corresponding to a first attribute;
determining a first magnitude value for the first attribute;
determining a rate of decay of the first magnitude value from a geographic point associated with the first attribute;
determining a first geographic boundary of a first geographic area based on a distance, determined by the rate of decay, from the geographic point;
detecting a second user input corresponding to a second attribute;
determining a second geographic area associated with the second attribute, the second geographic area defined by a second geographic boundary;
identifying a first geographic target location based on a first overlap region of the first geographic area and the second geographic area; and
presenting the first geographic target location in a graphical user interface (GUI) in response to the first user input.

5. The one or more computer-readable media of claim 4, wherein the first geographic target location includes a set of geographic addresses included in a census tract.

6. The one or more computer-readable media of claim 4, wherein the first attribute and the second attribute correspond to at least one of:
a service;
an activity;
a cost of living;
weather;
crime; and
politics.

7. The one or more computer-readable media of claim 4, wherein the operations further comprise:
receiving a third user input corresponding to a third attribute;
determining a third geographic area associated with the third attribute;
receiving a user input corresponding to a logical OR operation applied to the second attribute and the third attribute,
wherein identifying the first geographic target location based on the first overlap region is based at least on determining (a) the first geographic area does not overlap the third geographic area, and (b) the first geographic area overlaps the second geographic area.

8. The one or more computer-readable media of claim 4, wherein identifying the first geographic target location comprises:
applying a trained machine learning model to an input dataset comprising the first attribute, the first geographic area, the second attribute, and the second geographic area,
wherein the operations further comprise:
training a machine learning model to generate the trained machine learning model at least by:
obtaining a set of target location selection records, the set of target location selection records comprising:
attribute data comprising a set of selected attributes and a set of geographic areas corresponding to the set of selected attributes; and
at least one label corresponding to at least one target location.

9. The one or more computer-readable media of claim 4, wherein the first user input comprises:
an attribute identifier; and
a quantifying value for the attribute identifier,
wherein the first geographic boundary is determined based on the quantifying value.

10. The one or more computer-readable media of claim 4, wherein the first attribute is a subjective attribute,
wherein determining the first geographic area associated with the first attribute comprises:
generating a generative AI prompt (a) specifying the subjective attribute and (b) requesting a scoring of a set of locations based on the subjective attribute;
obtaining, from a generative AI model in response to the generative AI prompt, a particular scoring for a first location; and
determining the first geographic area based on the particular scoring for the first location.

11. The one or more computer-readable media of claim 4, wherein determining the second geographic area comprises determining a time to travel from a first geographic location associated with the first attribute using a first mode of transportation, wherein the second geographic area is defined by a second geographic boundary.

12. The one or more computer-readable media of claim 11, wherein the second geographic area comprises a first sub-area and a second sub-area,
wherein the first sub-area and the second sub-area are non-contiguous,
wherein the first mode of transportation includes traveling by airplane from the first sub-area to the second sub-area, and
wherein identifying the first geographic target location comprises determining the first geographic area overlaps the second sub-area.

13. The one or more computer-readable media of claim 12, wherein the first mode of transportation includes at least two modes of transportation comprising at least two of:
a private automobile;
a commercial automobile service;
a public train service;
a public transit service; and
a commercial airline service.

14. The one or more computer-readable media of claim 4, wherein the operations further comprise:
generating a first generative AI prompt including a target neighborhood personality category, a plurality of neighborhood identifiers corresponding to a respective plurality of geographic neighborhoods, and a request to generate scores for the plurality of geographic neighborhoods based on the target neighborhood personality;
inputting the first generative AI prompt to a generative AI model;
receiving, from the generative AI model, a plurality of scores corresponding to the plurality of neighborhood identifiers;
detecting a first user input specifying the target neighborhood personality category; and
based on detecting the first user input: presenting, in the GUI, a set of neighborhood personality category markers,
wherein the set of neighborhood personality category markers comprises:
a first neighborhood personality category marker for a first geographic neighborhood based on a first neighborhood personality category score, from among the plurality of scores, for the target neighborhood personality category.

15. The one or more computer-readable media of claim 14, wherein generating the first generative AI prompt comprises generating a set of one or more generative AI prompts to generate scores for a set of census tracts exceeding 80,000 census tracts based on a set of neighborhood personality categories exceeding 70 neighborhood personality categories, and
wherein the operations comprise generating a set of geographic neighborhood personality scores based on results generated by the generative AI model from the set of one or more generative AI prompts.

16. (canceled)

17. (canceled)

18. (canceled)

19. A method comprising:
detecting a first user input corresponding to a first attribute;
determining a first magnitude value for the first attribute;
determining a rate of decay of the first magnitude value from a geographic point associated with the first attribute;
determining a first geographic boundary of a first geographic area based on a distance, determined by the rate of decay, from the geographic point;
detecting a second user input corresponding to a second attribute;
determining a second geographic area associated with the second attribute, the second geographic area defined by a second geographic boundary;
identifying a first geographic target location based on a first overlap region of the first geographic area and the second geographic area; and
presenting the first geographic target location in a graphical user interface (GUI) in response to the first user input;
wherein the method is performed by at least one hardware processor.

20. The method of claim 19, wherein the first geographic target location includes a set of geographic addresses included in a census tract.

21. The method of claim 19, wherein the first geographic target location is presented in a map in the GUI.

22. The method of claim 19, wherein determining the first geographic boundary comprises:
modifying the first magnitude by a specified quantity for every additional mile away from the geographic point; and
generating the first geographic boundary around a location at which the first magnitude thus modified reaches a specified threshold value.

23. The method of claim 19, wherein identifying the first geographic target location comprises determining a second magnitude value for the first attribute within the first overlap region.
